(19) United States
(12) Patent Application Publication
(10) Pub. No.: US 2008/0120152 A1
(43) Pub. Date: May 22, 2008

(54) System and method for managing numerous facets of a work relationship

(76) Inventor: Frank McCrea, Toronto (CA)

Correspondence Address: MEREK, BLACKMON & VOORHEES, LLC, 673 South Washington Street, Alexandria, VA, 22314, US

(21) Appl. No.: 11/602,235

(22) Filed: Nov. 21, 2006

(51) Int. Cl. G06F 17/30; G06Q 30/00

(52) U.S. Cl. 705/7; 705/32

(57) ABSTRACT

A system and method of managing numerous facets of work relationships. In a preferred form, the system provides end-to-end integration of the contract resourcing process (“requisition to check”) for a multitude of clients and a multitude of service providers. Preferably, the system includes a logo management component that allows a logo or other identifying indicia of a user entity (e.g., client, vendor, sub-vendor, contractor, etc.) to be automatically associated with that particular entity in various environments of the system. The logo management component can accommodate an unlimited number of logos for an unlimited number of system users. Further, the system preferably includes a document management component that allows for the electronic storage and indexing of required and/or preferred documents (e.g., w-2, 1099, articles of incorporation, proof of GST#, security clearance, authorship/ownership rights, contract, master service agreement, confidentiality agreement, etc.) relating to the work relationship. The document management component, in its most preferred form, further allows an entity (e.g., contactor, client, vendor or other system user) to examine, in real time, all required and/or preferred documents in a work relationship. Moreover, the system preferably includes a market rate reporting component that allows an appropriate user entity (i.e., client, vendor, sub-vendor, contractor, etc.) to create and generate market rate reports providing the user entity with actual data showing current market rates and market rate trends to allow the client to better analyze and manage spending. The rates that can be tracked and reported on include but are not limited to requisition rates, submitted rates and hire rates. The status (i.e., active or inactive/past) of any of the foregoing rates can be tracked and reported. The market rate report aspect of the present inventions allows the user entity to customize the market rate report to meet the user entity's specific needs.

### FIELD OF THE INVENTION

The present invention relates to systems and methods of managing a work relationship. More particularly, the present invention relates to systems and methods for managing work relationships between one or more clients and one or more service providers (e.g., contractors, vendors, sub-vendors, etc.).

### BACKGROUND OF THE INVENTION

For many years, entities in the service industries have employed manual time sheet and billing systems as a way for service providers to record time spent on a work activity and thereafter be paid for the work. In a typical example, a contractor may submit to a potential client an estimate of the cost for a particular job in terms of time and materials. If the client reaches agreement with the contractor on the terms, the contractor's time can be recorded so that the client can review and approve the time spent by the contractor in performing the work. Typically, the contractor will write or type onto a timesheet the amount of time the contractor has worked over the course of the contract, usually on a per time unit basis (e.g., hours per day). Depending upon the length of the contract, the contractor might regularly submit aggregated time sheets covering a pre-determined period (e.g., one month) to the client for approval and payment. If the client approves the time spent by the contractor, the contractor can then draw up an invoice to provide to the client for payment. These manual systems suffer from numerous disadvantages.

Attempts have been made to automate the above procedure. For example, U.S. patent application Ser. No. 10/962,762 filed on Jun. 7, 2004 discloses a novel and unobvious automated system for managing the contract resourcing process from end-to-end (i.e., from requisition to hire).

A preferred form of the present invention seeks to provide an even further advanced automated system for managing the contract resourcing process from end-to-end.

### OBJECTS AND SUMMARY OF THE INVENTION

An object of a preferred embodiment of the present invention is to provide an automated system for managing work relationships between one or more clients and one or more service providers (e.g., contractors, vendors, sub-vendors, etc.).

Another object of a preferred embodiment of the present invention is to provide an automated system for managing work relationships between one or more clients and one or more service providers that automatically and readily tracks data relating to actual market rates (e.g., requisition rates, hire rates, submitted rates) of service providers so that market rate reports reporting actual market rates can be created and generated as desired by a system user.

A further object of a preferred embodiment of the present invention is to provide an automated system for managing work relationships that allows system users to create and generate market rate reports reporting actual market rates (e.g., requisition rates, hire rates, submitted rates) of service providers that are specifically tailored by the system user to meet the specific needs of the system user.

Yet another object of a preferred embodiment of the present invention is to provide an automated system for managing work relationships that permit market rate reports reporting actual market rates (e.g., requisition rates, hire rates, submitted rates) to be customized for a particular time frame, sector, industry, location, position, skills set or any combination thereof.

Still yet another object of a preferred embodiment of the present invention is to provide an automated system for managing work relationships that automatically tracks requisitions rates, hire rates and/or submitted rates so that market rate reports utilizing one or more of the foregoing rates can be created and generated.

Still a further object of the present invention is to provide an automated system for managing work relationships that automatically associates a logo (e.g., a word mark, design mark or other identifying indicia) of a user entity (e.g., client, vendor, sub-vendor, contractor, etc.) with that particular entity in various environments including system interface screens, invoices, reports, time sheets and/or notices (e.g., e-mails that are generated by a preferred embodiment of the present invention).

Yet still a further object of a preferred embodiment of the present invention is to provide an automated system for managing work relationships that allows for white labeling of various environments including system interface screens, invoices, reports, time sheets and/or notices (e.g., e-mails that are generated by a preferred embodiment of the present invention).

Another object of a preferred embodiment of the present invention is to provide an automated system for managing work relationships that provides a simple and virtually fool proof method of indexing and storing documents relevant to the work relationships being managed for subsequent retrieval and review.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one preferred embodiment of the present invention is directed to an apparatus for managing time related work activities of at least one worker for at least one client. The apparatus includes a computer system having a management component for managing at least one aspect of a work relationship. The computer system further includes a market rate report component for allowing a system user to create a market rate report reporting actual market rates of service providers. The market rate report component is configured to allow a system user to customize the market rate report reporting actual market rates of service providers using at least one of the following parameters: (i) title/position of service provider; and, (ii) skill set of service provider.

Another preferred embodiment of the present invention is directed to an apparatus for managing time related work activities of at least one worker for at least one client. The apparatus includes a computer system having a requisition module, a time track module and a reporting module. The requisition module is configured to track and manage procurement of labor resources. The requisition module includes one or more user interfaces for allowing a client or a service provider to enter information relating to procurement of labor resources. The information includes at least two of the following: (i) title/position, (ii) skills, (iii) industry, (iv) rate; (v) location; and (vi) status. The time track module is configured to track and manage time spent by one of more laborers. The reporting module is configured to allow a system user to create a market rate report reporting actual market rates from the information relating to procurement of labor resources entered by the client or the service provider. The reporting module is further configured to allow a system user to customize the market rate report to provide actual market rates of service providers specific to at least one of the following parameters: (i) title/position; (ii) skills; (iii) sector; (iv) industry; and (v) location.

A further preferred embodiment of the present invention is directed to an apparatus for managing time related work activities of at least one worker for at least one client. The apparatus comprises a computer system including a market rate report component for allowing a system user to create a market rate report reporting actual market rates of service providers. The market rate report component is configured to allow a system user to customize the market rate report reporting actual market rates of service providers using at least one of the following parameters: (i) title/position of a service provider; and, (ii) skill set of a service provider. The market rate report component includes a user interface configured to allow a system user to select one or more sorting criteria within at least one of the parameters.

Yet another preferred embodiment of the present invention is directed to an apparatus for managing time related work activities of at least one worker for at least one client. The apparatus comprises a computer system. The computer system has at least one of the following: (i) requisition tracking module for tracking and managing procurement of labor resources; (ii) invoice tracking module for preparing and tracking invoices; (iii) document tracking module for tracking documents relating to work activities of at least one worker for at least one client; and (iv) time tracking module for tracking information related to time worked by at least one worker for at least one client. The computer system further includes a logo management component for storing a plurality of logos. The plurality of logos includes a first logo identifying one of a first client and a first vendor and a second logo identifying one of a second client and a second vendor. The first vendor is different from the second vendor. The first client is different from the second client. The logo management component is configured to automatically and selectively display the first logo and the second logo at one or more desired locations in the computer system.

Still another preferred embodiment of the present invention is directed to a method for managing time related work activities of at least one worker for at least one client where the worker is represented by a vendor. The method comprises the steps of: (a) providing a computer system having at least one of the following: (i) requisition tracking module for tracking and managing procurement of labor resources; (ii) invoice tracking module for preparing and tracking invoices; (iii) document tracking module for tracking documents relating to work activities of at least one worker for at least one client; and (iv) time tracking module for tracking information related to time worked by at least one worker for at least one client; (b) providing the computer system further with a logo management component for storing a plurality of logos, the plurality of logos including a first logo identifying at least one client and a second logo identifying at least one vendor; and, (c) automatically and selectively displaying the first logo and the second logo at one or more desired locations in the computer system.

Yet a further preferred embodiment of the present invention is directed to an apparatus for managing time related work activities of at least one worker for at least one client. The apparatus comprises a computer system having a document tracking module for tracking documents relating to work activities of at least one worker for at least one client. The document tracking module includes a user interface having a plurality of panes. The plurality of panes includes a document listing pane for listing unassigned documents relating to work activities of at least one worker for at least one client. The plurality of panes further includes an identifying pane for identifying unassigned documents listed in the document listing pane.

### BRIEF DESCRIPTION OF THE DRAWINGS OF A PREFERRED EMBODIMENT OF THE PRESENT INVENTION

FIG. 1 is a schematic diagram illustrating one of numerous possible configurations of a preferred embodiment of the present invention.

FIGS. 2 and 3 are block diagrams showing sample interactions among users of the present invention in a thin client embodiment.

FIGS. 4 and 5 are flow charts illustrating sample steps in the candidate submission and time recordation and billing aspects, respectively, of a preferred embodiment of the present invention.

FIG. 6 is a schematic diagram showing various elements of a preferred embodiment of the present invention.

FIG. 7 is a schematic diagram illustrating a sample time sheet approval and bill presentment process formed in accordance with a preferred embodiment of the present invention.

FIG. 8 is a flow chart of the steps for creating and generating market rate reports in accordance with a preferred embodiment of the present invention.

FIG. 9 is a screenshot of a preferred requisition interface used by a client or other authorized user to create and generate ajob requisition.

FIG. 10 is a screenshot of an upper portion of a preferred system interface in which the name and details of a candidate may be submitted for a particular job requisition.

FIG. 11 is a screenshot of a lower portion of the system interface depicted in FIG. 10.

FIG. 12 is a screenshot of a preferred system interface used to confirm the details of a contract, i.e., the successful placement of a candidate.

FIG. 13 is a screenshot of a preferred system interface used to create and generate a market rate report that is specific to a particular job title/position and two specific skills.

FIG. 14 is a screenshot of a preferred system interface used to create and generate a market rate report that is specific to a particular client.

FIG. 15 is a screenshot of a preferred system interface used to create and generate a market rate report that is specific to a particular skill.

FIG. 16 is a screenshot of a preferred system interface used to create and generate a market rate report that is specific to a particular job title/position.

FIG. 17 is a screenshot of a preferred system interface used to create and generate a market rate report illustrating, inter alia, one of many possible configurations for the sector field.

FIG. 18 is a screenshot of a preferred system interface used to create and generate a market rate report illustrating, inter alia, one of many possible configurations for the industry field.

FIG. 19 is a screenshot of a preferred system interface used to create and generate a market rate report illustrating, inter alia, one of many possible configurations for the location field.

FIG. 20 is a flow chart of sample steps in managing one or more logos in accordance with a preferred embodiment of the present invention.

FIG. 21 is a schematic diagram illustrating various elements of a preferred embodiment of the present invention.

FIG. 22 is a screenshot of one form of login screen in accordance with a preferred embodiment of the present invention.

FIG. 23 is a screenshot of one form of user interface formed in accordance with a preferred embodiment of the present invention.

FIG. 24 is a screenshot of another form of login screen in accordance with a preferred embodiment of the present invention.

FIG. 25 is a screenshot of a user interface in which a white-labeled invoice is displayed in one portion and logos of two different system users are displayed in another portion.

FIG. 26 is a flow chart of sample steps in managing documents in accordance with a preferred embodiment of the present invention.

FIG. 27 is a schematic diagram illustrating various elements of a preferred embodiment of the present invention.

FIG. 28 is a schematic diagram illustrating various elements of a preferred embodiment of the present invention.

FIG. 29 is a screenshot of a preferred user interface listing reports that can be produced by a preferred embodiment of the present invention.

FIG. 30 is a screenshot of a preferred user interface including a plurality of different fields for customizing a document management report. The user interface also displays the results of document management report corresponding to an entered search criteria.

FIG. 31 is a flow chart of sample steps of a transfer program operated in accordance with a preferred embodiment of the present invention.

FIG. 31A is a flow chart of sample steps of a transfer program operated in accordance with a preferred embodiment of the present invention.

FIG. 32 is a screenshot of a preferred user interface used in a transfer program formed in accordance with a preferred embodiment of the present invention.

FIG. 33 is a screenshot of a preferred user interface used in a transfer program formed in accordance with a preferred embodiment of the present invention.

FIG. 34 is a screenshot of a preferred user interface used in a transfer program formed in accordance with a preferred embodiment of the present invention.

FIG. 35 is a screenshot of a preferred user interface used in a transfer program formed in accordance with a preferred embodiment of the present invention.

FIG. 36 is a screenshot of a preferred user interface used in a transfer program formed in accordance with a preferred embodiment of the present invention.

FIG. 37 is a screenshot of a preferred user interface used in a transfer program formed in accordance with a preferred embodiment of the present invention.

### DETAILED DESCRIPTION OF THE PREFERRED EMBODIMENTS OF THE INVENTION

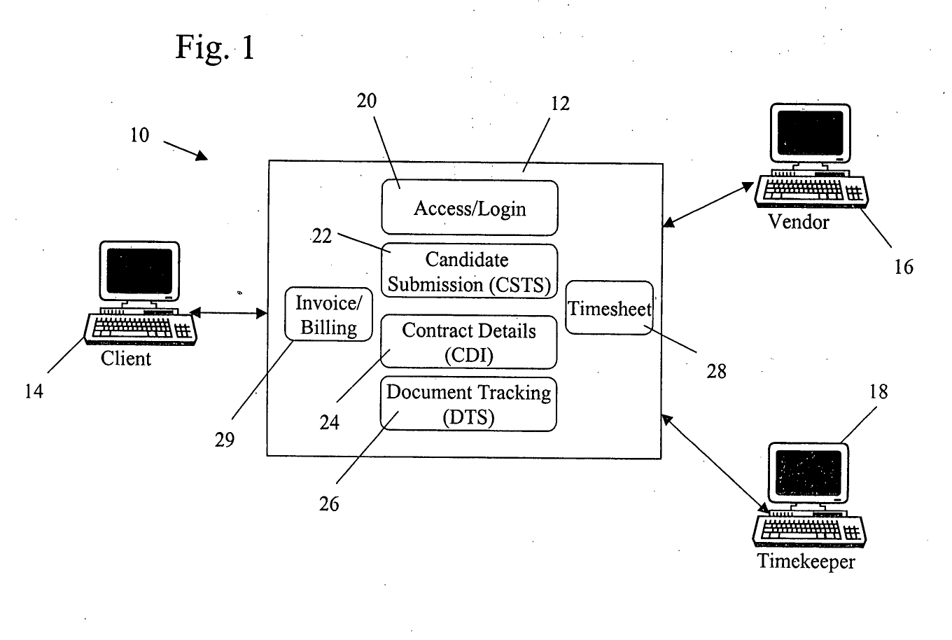

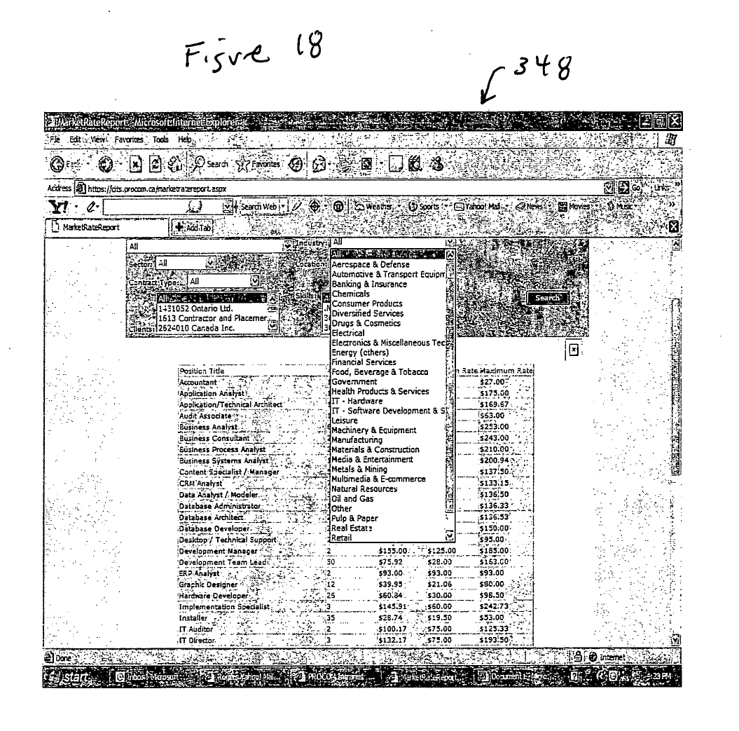

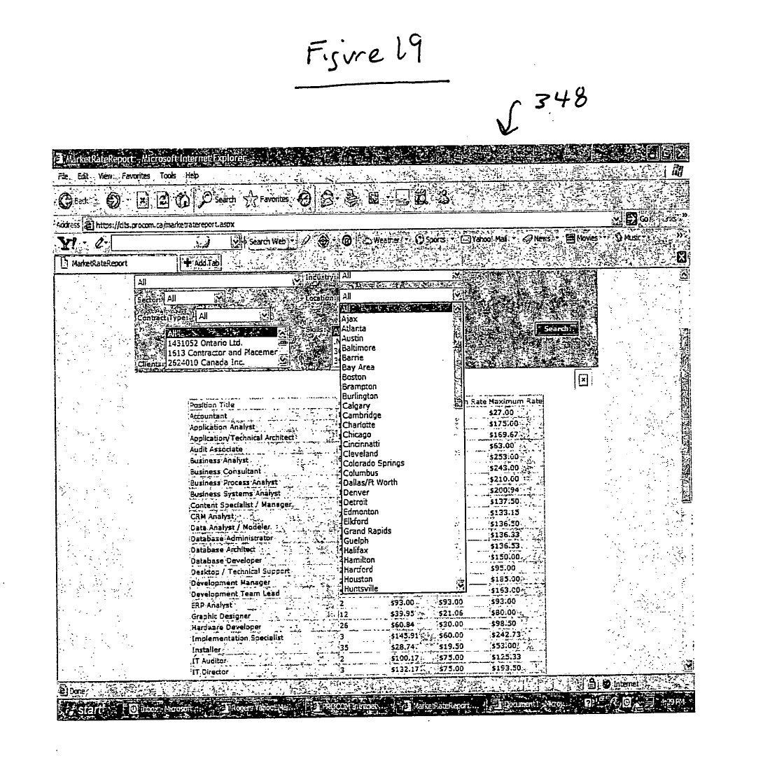

The preferred forms of the invention will now be described with reference to FIGS. 1-37 The appended claims are not limited to the preferred forms and no term and/or phrase used herein is to be given a meaning other than its ordinary meaning unless it is expressly stated that the term and/or phrase shall have a special meaning.

As shown in FIGS. 1 to 3, the most preferred form of system 10 of the present invention includes a management component 12 in two-way communication with at least one administrator 13, at least one client 14, at least one vendor/supplier 16 and at least one timekeeper 18 for managing numerous facets of the work relationship. The term “client” in this context refers to an entity contracting with one or more workers to receive performance, typically in the form of specified services, from the one or more contractors performing the work. The present invention allows the client 14 to review, approve and monitor various aspects of the work relationship as more fully explained below. A “client manager” can be a client user of the systems and methods of the present invention. The term “vendor” or “supplier” in this context refers to an entity that supplies contract resources, such as a placement or temporary contracting agency. Such entities typically act as an intermediary between qualified individuals and companies and clients desiring their employ. The terms “timekeeper”, “contractor” and “consultant” can be used interchangeably in this context to refer to individuals who are employed by the client to provide performance of a contract, typically in the form of services. A “managing consultant” can be an individual associated with one or more contractors, either as part of the contractor entity or the vendor entity, who might use the systems and methods of the present invention. The term “administrator” in this context refers to an entity that is responsible for maintaining and administering the systems and methods of the present invention. The administrator may also be one of many vendors that simultaneously use the present invention. Alternatively, the administrator may be affiliated (e.g., parent, subsidiary, sister company) with one or more vendors that use the present invention.

The configuration and operation of system 10 for providing end-to-end integration of the contract resourcing process is explained in detail in U.S. patent application Ser. No. 10/962,762 filed on Jun. 7, 2004, the entire contents of which are incorporated herein by reference. It will be readily appreciated that one or more aspects of the present invention may be used with the system disclosed in U.S. patent application Ser. No. 10/962,762. Alternatively, one or more aspects of the present invention may be used with only certain portions of the system disclosed in U.S. patent application Ser. No. 10/962,762. Further, the present invention may be used with a system different from that disclosed in U.S. patent application Ser. No. 10/962,762. Accordingly, the reference to U.S. patent application Ser. No. 10/962,762 is not to be used to limit the scope of the subject claims. Moreover, if a difference between terminology used in the present application (i.e., without reference to the material incorporated by reference) with terminology used in U.S. patent application Ser. No. 10/962,762 is deemed to exist, the terminology of the present application (i.e., without reference to the material incorporated by reference) is to govern the interpretation of terms in the claims of the subject patent application.

The most preferred form of system 10 includes a logo management feature that allows a logo (e.g., a word mark, design mark or other identifying indicia) of a user entity (e.g., client, vendor, sub-vendor, contractor, etc.) to be automatically associated with that particular entity in various environments of system 10. For example, the preferred form of the logo management feature automatically places the appropriate logo of one or more user entities on system interface screens, invoices, reports, time sheets and/or notices (e.g., e-mails that are generated by the present invention). The logo management feature also provides for white labeling. For example, the login screen displayed when a particular contractor and/or vendor is using the preferred form of the invention can be white labeled for a given vendor. Similarly, the invoice can be white labeled for a given vendor. While these are two examples of white labeling, it will be readily appreciated that white labeling can be used wherever desired. The logo management feature of the preferred form of the present invention reduces vendor resistance and promotes vendor neutrality. The logo management feature of the preferred form of the present invention also allocates responsibility/credit where such is due. For example, if a contractor working under vendor X has performed superiorly, vendor X, as opposed to the system administrator or some other entity is given credit for the superior performance of the contractor. The logo management feature of the preferred form of the present invention is particularly beneficial where the administrator is also a vendor or an entity affiliated with a vendor. The logo management feature of the preferred form of the present invention is more fully explained below.

Another aspect of a preferred form of system 10, i.e., the document management feature, allows for the electronic storage and indexing of required and/or preferred documents (e.g., w-2, 1099, articles of incorporation, proof of GST#, security clearance, authorship/ownership rights, contract, master service agreement, confidentiality agreement, etc.) relating to the work relationship. The document management feature, in its most preferred form, further allows an entity (e.g., contactor, client, vendor or other system user) to examine, in real time, all required and/or preferred documents in a work relationship. The document management feature, in its most preferred form, can accommodate an unlimited number of documents. The electronic storage and indexing of documents allows a system user to readily examine documents for compliance with local regulations, federal regulations and/or internals rules and/or procedures of one or more user entities. For example, a client and/or vendor can view in real time all documents submitted by all contractors on a given contract to ensure that all contractors have submitted the documentation required by federal law, local law and/or internal rules of the client and/or vendor. The document management feature of the preferred form of the present invention further allows for the creation and generation of document management reports that are specifically tailored or customized to the needs of a particular entity. For example, an administrator, by using the appropriate user interface screen can create, have displayed and generate a document management report that readily identifies for all clients, all contracts and all consultants whether certain documents have been received. Further, by using the appropriate interface screen, the administrator can display one or more documents by merely clicking on a designated portion of the appropriate interface screen. The document management feature of the preferred form of the present invention can be configured to allow other entities (e.g., client, vendor, contractor, etc.) to create, have displayed and generate a document management report. The document management feature may be configured to restrict access of certain entities. For example, the access of a contractor may be limited to only contracts on which he or she is working. Similarly, a client's and/or vendor's access may be limited to reports on documents relevant to only that client and/or that vendor.

The document management feature of the preferred form of the present invention reduces the risk that a user entity (e.g., client, vendor, etc.) will violate federal and/or local laws/regulations governing employment relationships. The preferred form of the document management aspect of the present invention also stream lines the storage and indexing of documents by providing a simple and efficient procedure for electronically storing, displaying and indexing documents so that such documents can be readily retrieved and viewed as desired. The preferred form of the document management aspect of the present invention also reduces overhead and can dramatically reduce storage space previously occupied by hard copies. The document management feature of the preferred form of the present invention is more fully explained below.

A further aspect of the preferred form of system 10, i.e., the market rate report aspect, allows an appropriate user entity (e.g., client, vendor, sub-vendor, contractor, etc.) to create and generate market rate reports providing the user entity with actual data showing current market rates and market rate trends to allow the client to better analyze and manage spending. The rates that can be tracked and reported on include but are not limited to requisition rates (i.e., pay rates at which a client has initially posted a job), submitted rates (i.e., pay rates submitted by a vendor and/or contractor for a given job posted by a client) and hire rates (i.e., the pay rates that were actually agreed upon by the client and vendor and/or contractor). The status (i.e., active or inactive/past) of any of the foregoing rates can be tracked and reported. The market rate report aspect of the present inventions allows the user entity to customize the market rate report to meet the user entity's specific needs. For example, the user entity can customize the market rate report for a particular time frame, sector, industry, location, position, skills set or any combination thereof. The market rate report feature of the preferred form of the present invention is an invaluable tool as it transforms rate management from an art to a science. More specifically, the market rate report feature allows one to evaluate real data on actual rates as opposed to speculate on what rates should be for a given job. Further, it allows an entity to evaluate numerous trends relating directly to market rates. For example, a vendor can monitor one or more clients' requisition rates versus hire rates to see if a particular client has a tendency to submit requisitions at lower rates than the client is actually willing to pay for a particular service. This is just one of numerous trends/tendencies that can be accurately reported on by the market rate report feature of the present invention.

It should be noted that while system 10 may include all three features referred to above (i.e., the market rate report feature, the document management feature and the logo management feature), it could include only one of these features or any two of these features. In other words, the present invention is not limited to systems and methods that use all three features.

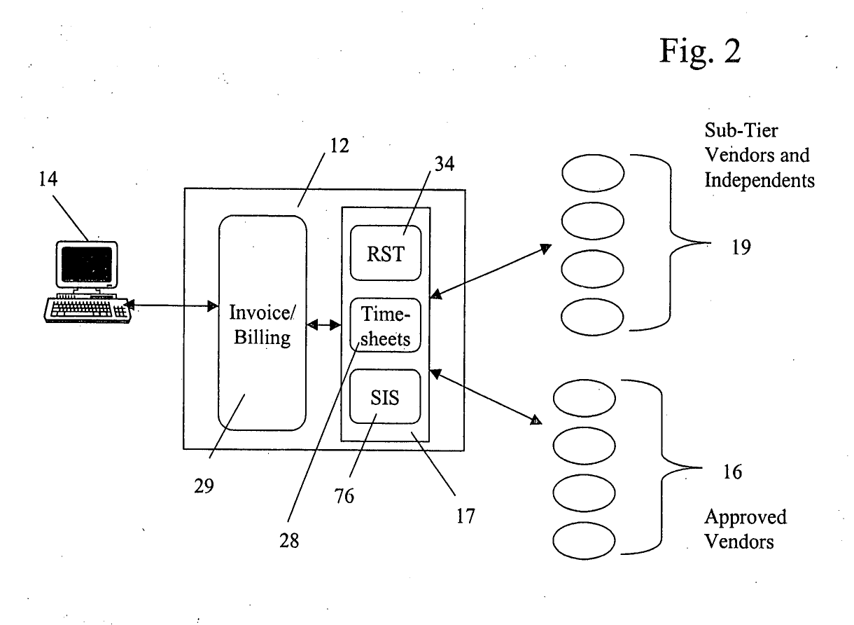

Referring to FIG. 1, management component 12 most preferably is provided in the form of a secure web site accessible via a public network such as the Internet, for example. As shown in FIG. 1, management component 12 includes sub-components such as access/login component 20, candidate submission and tracking system (CSTS) component 22 (also known as requisition module), contract data/details input (CDI) component 24, document tracking system (DTS) component 26 and timesheet component 28. A billing component 29 can also be part of management component 12, as shown in FIGS. 1 and 2, or can be a separate component interacting with management component 12.

Access/login component 20 provides a level of security to the present invention, by requiring any entity accessing the management component to be appropriately authorized and provided with at least one element of security (e.g., password, spoken input, fingerprint scan). Further, the access/login component 20 allows the system 10 to readily and automatically restrict a given user entity's access to one or more portions of system 10. Specifically, by assigning a user entity a unique login and associating an authorization level for that user with the user entity login, the system 10 can readily restrict any user entity's access to any portion of system 10. For example, contractor X is provided a login unique to contractor X. Contractor X is assigned a particular authorization that is indexed or otherwise associated with contractor X's login. Contractor X's authorization can prohibit contractor X from creating and generating market rate reports and/or from accessing any electronically stored documents other than contractor X's own personal documents (e.g. W-2, etc.).

CSTS component 22 allows client 14 to present requisition information to the system so as to receive qualified candidates for a particular job, and also allows vendors 16 and even individual contractors 18 to submit one or more candidates (which may be themselves, in the case of a contractor submission) in response to the requisition notice from the client. In short, CSTS component 22 manages the candidate submission workflow from requisition to hire, tracks job status and information related to the requisitioning process, and reports on hiring process and other metrics.

CDI component 24 allows for the creation, editing, extension, reporting, storage and integration of contract details associated with a contracted-for job, which can trigger certain business rules affecting the timesheet and billing system aspect of a preferred form.

DTS component 26 provides for the management, reporting, storage and tracking of documents and communications affecting components 22, 24, 28 and 29, including invoicing and payment.

Timesheet component 28 provides interfaces and communications necessary to input, transmit and report timesheets for a particular contractor on a particular project, receive feedback and/or approval of the transmitted timesheet from the client, and process the timesheet for billing once approved. Timesheet component 28 may be the primary interface for the contractor.

Billing component 29 interacts with timesheet component 28 to automate processing of invoices and payment in connection with approved timesheets.

The preferred forms of management component 12, CSTS component 22, CDI component 24, DTS component 26 and timesheet component 28 are more fully described in U.S. patent application Ser. No. 10/962,762 filed on Jun. 7, 2004.

As described herein, certain exemplary embodiments of the invention can be implemented using a plurality of computers which, depending on circumstances, may communicate over one or more networks of computers such as, e.g., a local area network (LAN), a wide area network (WAN), a public network, such as the Internet, for example and/or another network. In various embodiments, as described herein, one or more servers, client computers, application computers and/or other computers can be used to implement one or more aspects of the invention. As an example, management component 12 can be a single computer having memory and programming sufficient to accommodate the requirements of sub-components 20, 22, 24, 26 and 28. Alternatively, individual dedicated computers can be provided with memory and programming to accommodate the requirements of a respective component or sub-component. In one embodiment, the invention can be deployed in an application service provider (ASP) format, with users accessing the invention using a public network, such as the Internet, for example.

Illustrative computers for use with the present invention can include, for example, a central processing unit, memory (ROM, RAM, etc.), digital data storage (e.g., hard drives, etc.), input/output ports (e.g., parallel and/or serial ports, etc.) and data entry devices (e.g., keyboards). User computers may contain, in some embodiments, browser software for interacting with the server such as, for example, using hypertext transfer protocol (HTTP) to make requests of the servers via the Internet or the like, in addition, various computers can include other protocols as needed to effectuate communications described therein, such as, for example, file transfer protocol (FTP) for transferring, uploading and/or downloading files and/or the like.

Additionally, in some exemplary embodiments, the system can use relational databases, such as, for example, employing a relational database management system (RDBMS) program to create, update and/or administer a relational database. The RDBMS can be adapted to take Structured Query Language (SQL) statements entered by a user or contained in an application program and create, update and/or provide access to database(s). Some illustrative RDBMS's include Oracle™ databases, and IBM DB2™ databases. In some illustrative embodiments, one or more user computers can be provided, such as, for example, as a LAN-based system. The user computers can include an appropriate operating system, such as, for example, Windows N™ or other systems known in the art. The system can also provide an object based graphical user interface (GUI) on one or more user computers.

In some illustrative embodiments, process steps can be carried out via computers by way of their central processing unit (CPU), which can communicate with a set of input/output (I/O) devices over a bus. The I/O devices can include, for example, a keyboard, mouse, video monitor, printer and/or other devices. The CPU can communicate with a computer readable medium (e.g., conventional volatile or non-volatile data storage devices) and/or memory over the bus. The interaction between a CPU, I/O devices, a bus and a memory will be appreciated by those of ordinary skill in the art. Memory can include, for example, data and can also store software. The software can include a number of modules for implementing the steps of processes, such as computer implemented steps of the processes described herein. Conventional programming techniques can be used to implement these modules.

In at least one embodiment of the present invention, the various methods described herein can be implemented in computer program products for use with a computer system. This implementation may, for example, include a series of computer instructions fixed on a computer readable medium (e.g., a diskette, CD-ROM, ROM or the like) or transmittable to a computer system via an interface device, such as a modem or the like. The medium may be substantially tangible (e.g., communication lines) and/or substantially intangible (e.g., wireless media, infrared, etc.). The computer instructions can be written in various programming languages and/or can be stored in one or more memory devices, such as semiconductor devices (i.e., chips or circuits), magnetic devices, optical devices and/or other memory devices. Transmission can occur using appropriate communications technology.

As shown in FIG. 2, one embodiment of the present invention allows a client 14 and its vendors 16 and sub-tier vendors 19 to interact with management component 12. As shown in the embodiment of FIG. 2, invoice/billing component 29 is incorporated to allow the client 14 to view and approve contractor invoices, and to further allow bills to be automatically generated. It will be appreciated, in this embodiment, that both approved vendors 16 and sub-tier vendors and/or independent contractors 19 are in two-way communication with a vendor access component 17 of management component 12. In this embodiment, vendor access component 17 can include timesheet component 28, a supplier inquiry system (SIS) 76 and a retail sales tax component (RST) 34. Vendor access component 17 can be part of management component 12, or can be logically or physically separate from management component 12. While FIG. 2 shows an embodiment of the invention with a billing option, it will be appreciated that the present invention can also operate in a thin client environment with no billing option. In such an embodiment, approved vendors can view vendor-specific information directly through a separate vendor access component 17.

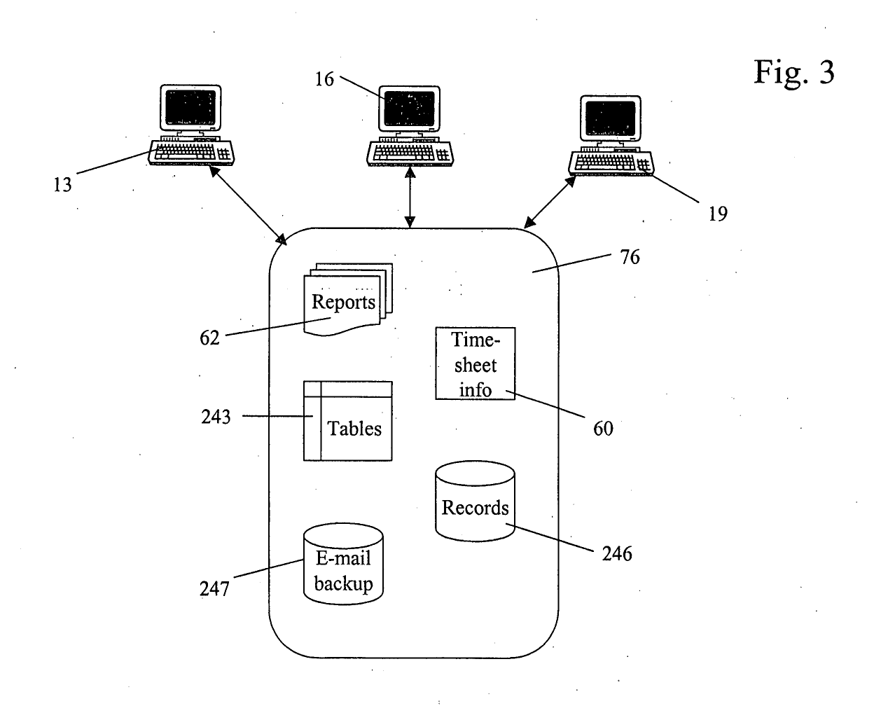

As shown in FIG. 3, SIS 76 allows administrative personnel 13 as well as suppliers, such as approved vendors 16 and sub-tier vendors and independents 19, to access timesheet information 60, reports 62, tables 243, records 246 and e-mails 247 formed in the operation of the present invention. As previously explained, the ability of any system user to access various portions of the system may be readily restricted.

RST component 34 is more fully described in U.S. patent application Ser. No. 10/962,762 filed on Jun. 7, 2004.

The communications component of the present invention, which can be part of DTS in one embodiment, can issue alerts to appropriate entities regarding an entities specific business rules or general business rules. For example, an entity may be alerted to matters of concern, such as purchase order (PO) exhaustion, contract expiry, time sheet rejection, and/or missing time sheets.

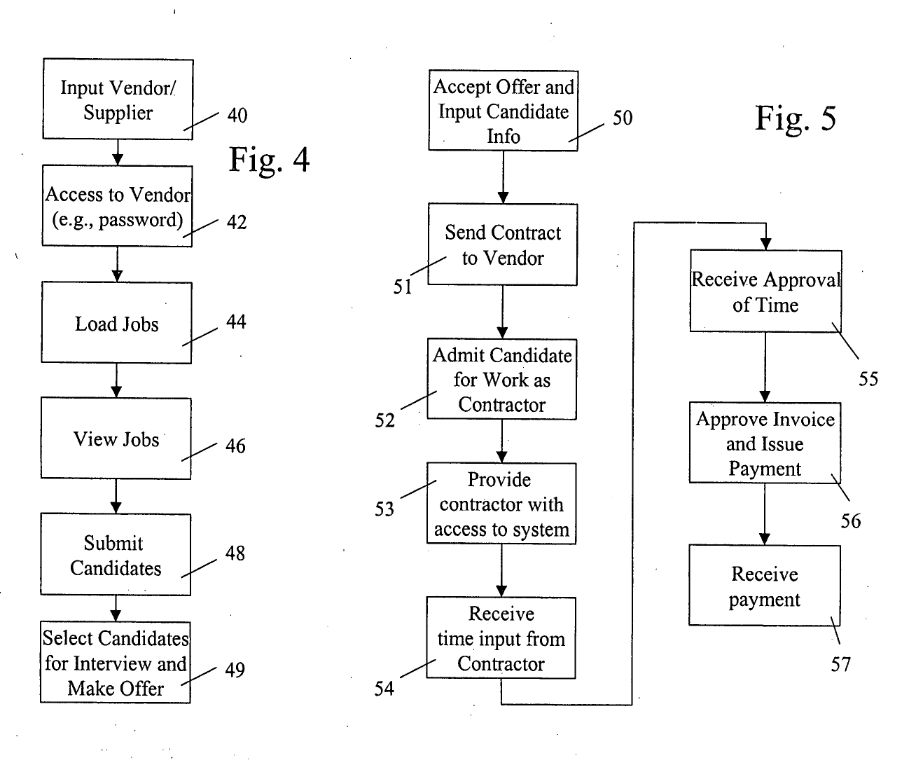

FIG. 4 illustrates example process steps involved in requisitioning labor for performance for the client. As at 40, the vendor and/or supplier of contractor assistance is inputted, and access to the vendor is granted via a login (e.g., password or the like) as at 42. Available jobs are then loaded as at 44 and presented for viewing by the vendor as at 46. Upon finding appropriate job matches for candidates affiliated with the vendor, the vendor can submit such candidates as at 48. A client can then select candidates for interview and make offers as deemed appropriate as at 49. FIG. 5 illustrates sample process steps involved with contracting with a contractor, receiving timesheets from the contractor and providing payment from the client. As at 50 in FIG. 5, the selected candidate can accept the client's offer of work and the candidate's information can be inputted into the system. A contract can then be sent to the vendor for the candidate as at 51. Once the candidate is admitted for work as a contractor as at 52, the contractor can be provided with access to the system of the invention as at 53. During course of performance of the work and as agreed by contract, the contractor can then input time into the system as at step 54. This time is then presented to the client for approval in accordance with the details described hereinafter, and if the client is agreeable to the entered time, the client notifies the system of approval of the contractor's time as at 55. The system of the present invention then approves the invoice presented by the contractor/vendor and issues payment as at 56. The vendor then receives payment as at 57. Examples of user interfaces associated with the steps in FIGS. 4 and 5 are described in U.S. patent application Ser. No. 10/962,762 filed on Jun. 7, 2004.

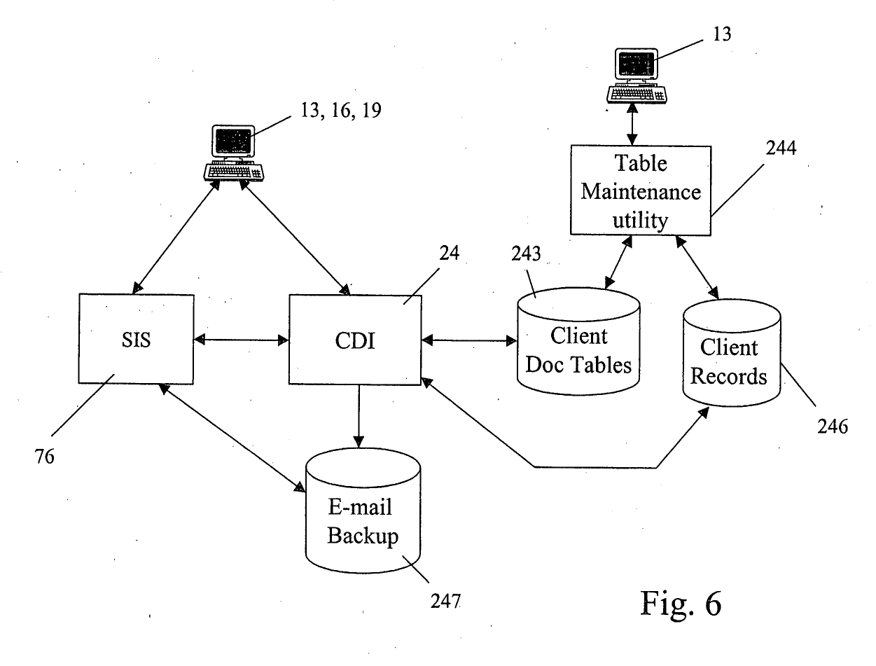

One aspect of the present invention is the ability to track, store, document and manage information relating to work relationships. Steps 44 and 48 refer to jobs being loaded (creation of requisitions) and candidates submitted, respectively. The data input in step 44 including but not limited to position/title, billing rate, job number, skills set, experience, duration, sector, location, time frame, type of employment (e.g. contract, full-time), client, etc., can be tracked by CSTS component 22 and stored in tables or otherwise for use in other aspects of the present invention including generating market rate reports as well as other reports. Similarly, the data input in step 48 including but not limited to billing rate, job number, skill set, experience, supplier, vendor, availability, etc. can be tracked by CSTS component 22 and stored in tables or otherwise for use in other aspects of the present invention including generating market rate reports as well as other reports. It should be noted that the present invention can be readily adapted to track and store other data in steps 44 and 48 as desired. For example, the job posting for one client may include numerous other details that can be tracked and stored for subsequent use. Step 51, in FIG. 5, refers to sending a contract for work to the vendor. Once the contract is approved and executed by the parties, contract data input (CDI) component 24 can track and store data including but not limited to hire rate, client, vendor, contractor, skill set, experience, location, sector, time frame, type of employment, duration, position/title, etc. for use in other aspects of the present invention including generating market rate reports as well as other reports. The status (e.g., active or inactive) of the employment relationship may also be tracked, stored and updated for use in other aspects of the present invention including generating market rate reports as well as other reports. All such data can be stored in tables as at 243 in FIG. 6 and retrieved as desired. However, it will be readily appreciated that the present invention is not limited to tables for storing data. Rather, any suitable storage method may be used.

As further shown in FIG. 6, administrative personnel 13 can manipulate the set up and contents of table database 243 via table maintenance utility 244. Also, administrative personnel 13, approved vendors 16 and sub-tier vendors 19 can access SIS and CDI, which can further communicate with each other. SIS permits access to items such as, for example, timesheet information 60, reports 62, tables 243, records 246 and e-mails 247 formed in the operation of the present invention.

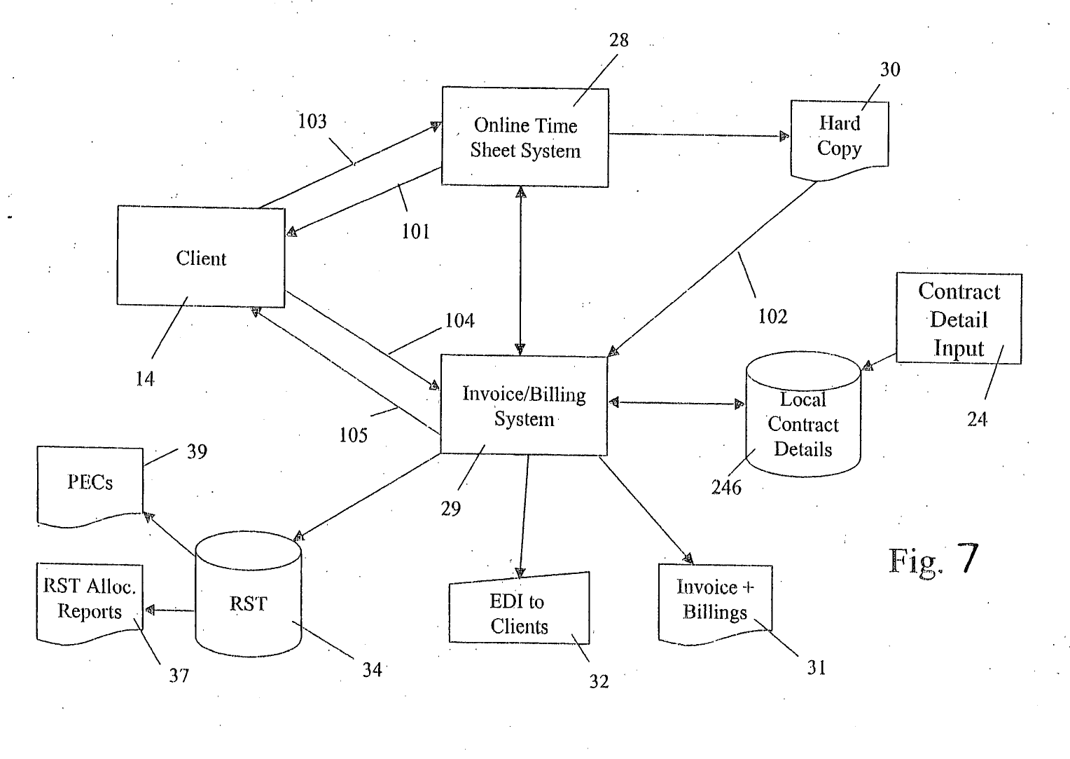

As shown in FIG. 7, time sheet system 28 and billing system 29 interact to process timesheets as required (e.g., “blue ink” signature, electronic) by the client 14. Timesheet requirements can be indicated by the client at the time contract details are entered into the system of the present invention. In one embodiment, timesheet component 28 includes a contract term implementation component to automatically set timesheet recordation and transmission protocols pursuant to the contract terms and/or the client's preferred format indication. Once a contractor has finalized his or her timesheet, if the timesheet is permitted by the client to be submitted in electronic form, the time sheet system can submit it to client as at 101 for client review. If the timesheet must be submitted with “blue ink” signature, a hard copy 30 can be printed using timesheet component 28, signed and faxed or otherwise transmitted as at 102 to billing system for presenting to the client. In the case where the contractor and client are in close physical proximity to one another, a blue ink signature time sheet can be hand delivered to the client for approval. If the timesheet is not acceptable, the client can provide explanatory feedback as at 103 to the contractor via the timesheet system 28. Such feedback can also be directed by the client to the client's accounting department and/or the contractor's managing consultant. If the timesheet is acceptable, the client can indicate such as at 104 to billing system 29.

As further shown in FIG. 7, the CDI component 24 of the present invention can store contract details in database 246 for use by billing system component 29. Billing component 29 can retrieve items such as the invoice history for the client, or purchase order details, and forward such information to the client 14 as at 105 at the appropriate time. It will be appreciated that billing system component 29 can also present hard copies 31 of invoices and billings, and can transmit information 32 using electronic data interchange (EDI) to clients. RST component 34 facilitates accounting and reporting of retail sales tax, which may or may not be attributed depending upon the jurisdictions involved in a particular client's employment of a particular contractor. In one embodiment, if the client is not exempt from sales tax, the tax would be added to the invoice at the time of presentment to the client for payment. Such information can be presented in an RST allocation report as at 37, for example. If the client is not subject to retail sales tax, the present invention can facilitate completion of a purchase exemption certificate (PEC) 39, as required.

It will be appreciated that management component 12 can include software to facilitate certain business processes as part of a comprehensive contract management service (e.g., the Procom SoftLanding™ program, commercially available from Professional Computer Consultants, Ltd. of Toronto, Canada) in connection with the present invention. Such business processes can include, for example, corporate governance, document management, contractor performance reviews, project budget control and reporting, rate analysis, “psuedo-employment”, retail sales tax information and cost projection. It will also be appreciated that the present invention can be used in stand-alone mode, as well as alongside a vendor or client's own timesheet and/or billing software.

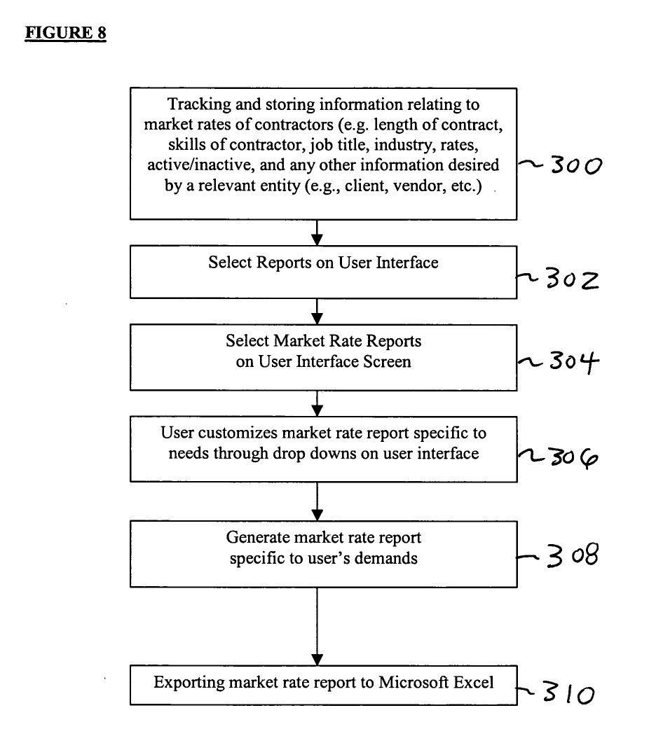

Referring to FIG. 8, a preferred method including steps 300, 302, 304, 306, 308 and 310 is illustrated for creating and generating one or more market rate reports readily customized by the system user. It will be readily appreciated that one or more steps may be omitted. Further, one or more steps may be consolidated. Moreover, the sequence of one or more steps may be varied.

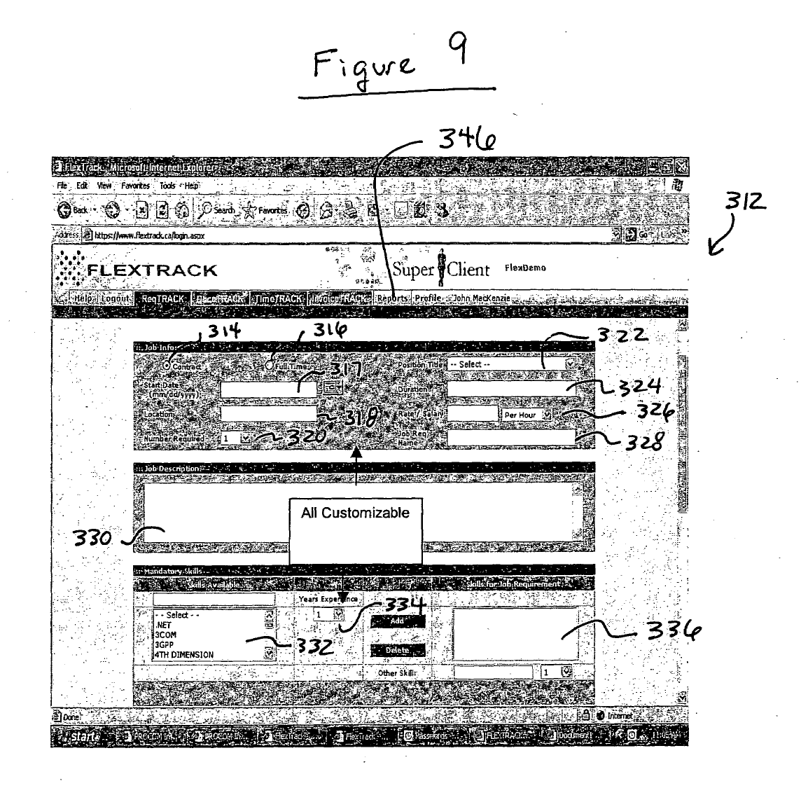

In step 300, information relating to market rates of contractors is tracked and stored. The information may include any information desired by a system user. For example, the information may include length of contract, skills of contractor, job title, industry, sector, rates, time frame, status, etc. In the most preferred form, a client interface 312 (See FIG. 9) is provided that allows a client or other authorized person to create a job requisition. The client or other authorized individual can readily customize the job requisition through interface 312 as shown in FIG. 9. For example, a client may specify the type of employment using radio buttons 314 and 316 (e.g., contract or full-time). Through sections/fields 317, 318, 320, 322, 324, 326 and 328, a user may identify the start date, the location of the job, the number of persons needed for the job, the position/title of the job, the duration of the job, the pay rate and the job requisition number, respectively. Section 330 of interface 312 allows a user to provide a description of the job. Sections 332, 334 and 336 of interface 312 allow a user to identify mandatory skills for a job and the required years of experience. It will be readily appreciated that the interface screen 312 may be modified as desired. For example, interface 312 could include a section for identifying preferred but not mandatory skills. Once all of the information has been entered, the system user merely clicks on the submit section (not shown) of the interface and the job requisition is automatically created. Information entered by an individual using interface 312 is tracked and stored by CSTS component 22 for subsequent use. Further, this information can be updated or otherwise modified by the client, administrator or other authorized user as desired.

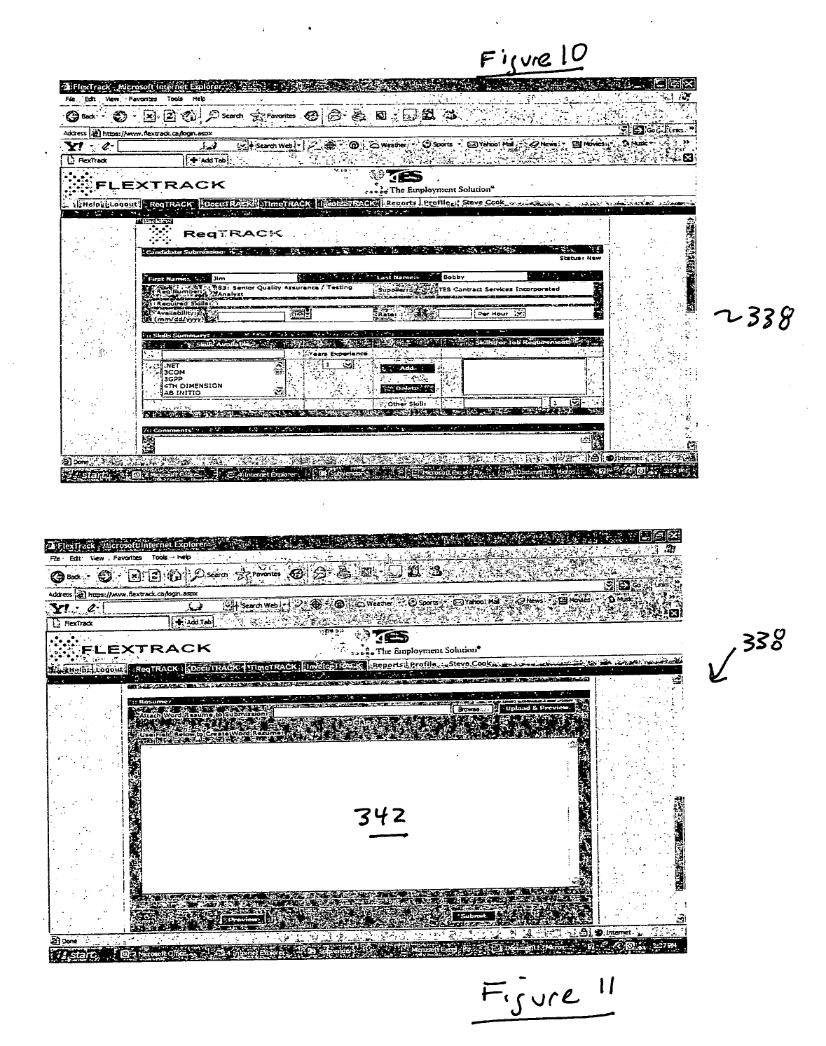

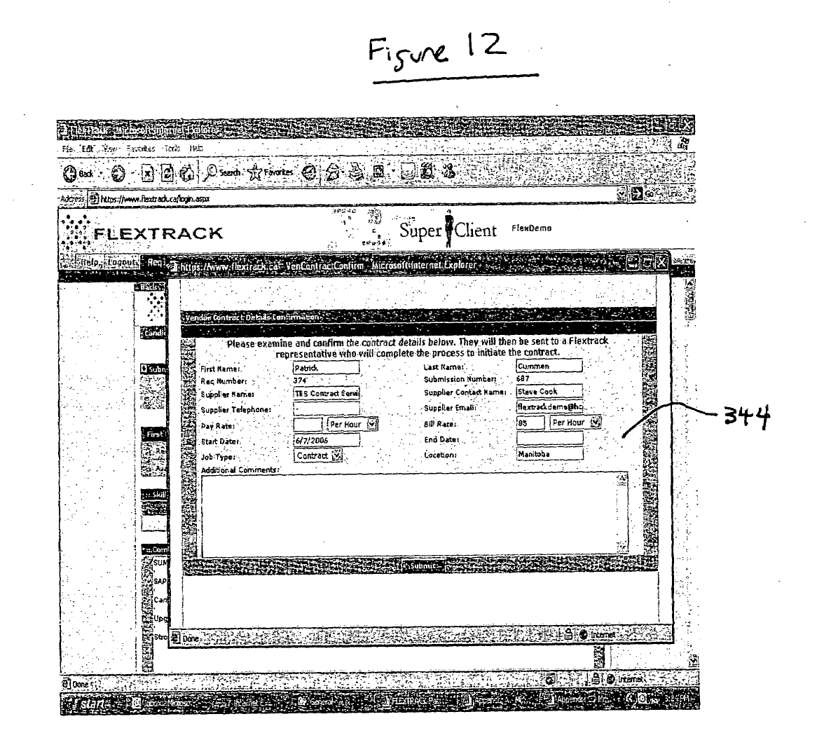

User interface 338 depicted in FIGS. 10 and 11 allows a vendor or other authorized user to submit a candidate for a specific requisition. FIG. 11 is merely a scrolled down version of the screen shot depicted in FIG. 10. Interface 338 is configured to allow a system user to submit detailed information about a particular candidate including name, vendor representing the candidate, pay rate, skill set of the candidate and years of experience. Interface 338 further allows a resume of a candidate to be attached or typed in field 342 as shown in FIG. 11. Once the necessary information is entered by a system user, the system user merely clicks on the submit section of interface 338 and the information regarding the candidate is transmitted to the appropriate client or other system user. This allows the appropriate user to review the candidate's qualifications and determine whether to hire the candidate. Information entered by an individual using interface 338 is tracked and stored by CSTS component 22 for subsequent use.

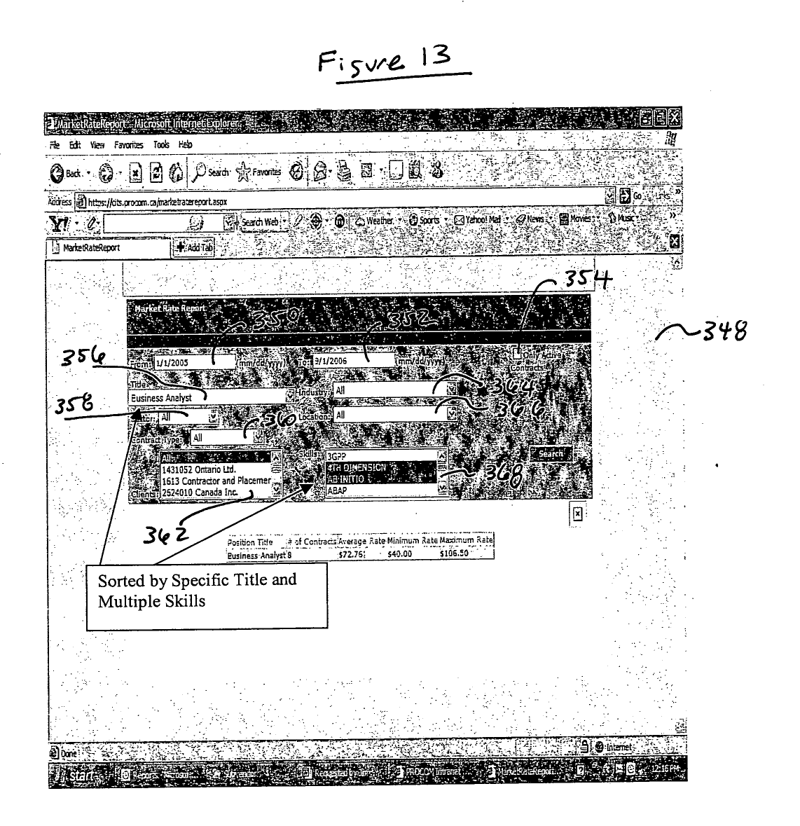

Once a candidate is selected for employment, a screen 344 is displayed seeking confirmation of the contract details (e.g., FIG. 12). The contract details are tracked and stored by CDI component 24. In this manner, the system of the present invention is able to readily track and store any information relating to labor procurement desired. The information tracked by CSTS component 22 and CDI component 24 can be stored in one or more tables and subsequently accessed to create a market rate report.

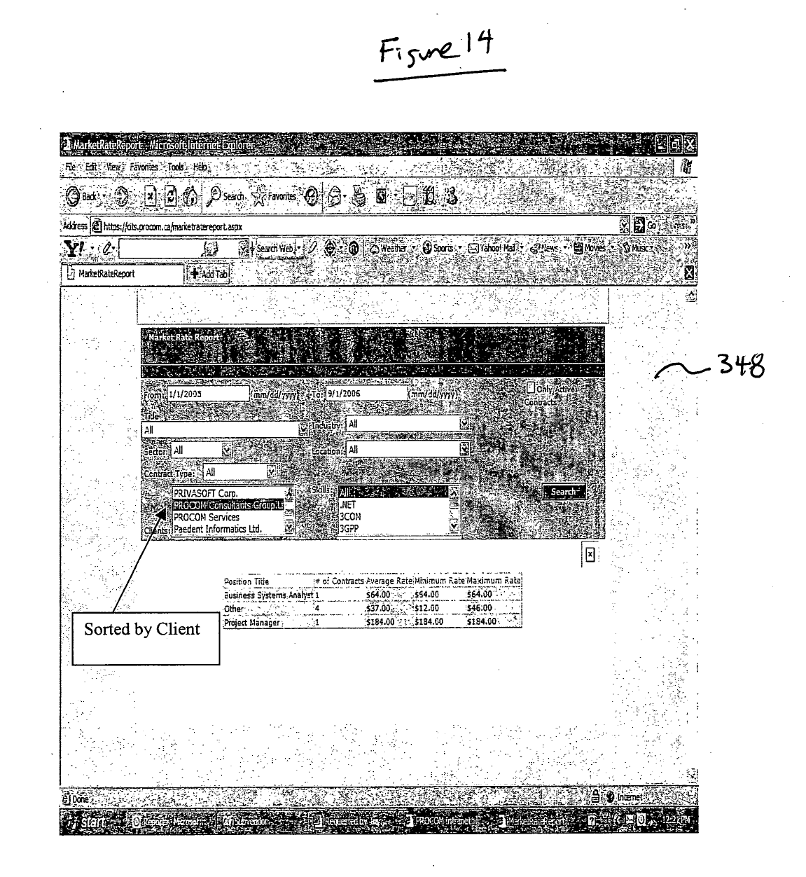

In step 302 in the preferred process of creating and generating a market rate report, the user merely clicks on the reports module 346 on any appropriate interface (e.g., FIG. 9). The user is then presented with a screen listing the various reports that can be created by reports module 346. In step 304 in the preferred process of creating and generating a market rate report, the user clicks on the market rate report and is provided an interface 348 (e.g., FIG. 13). In step 306 in the preferred process of creating and generating a market rate report, a system user can tailor a market rate report to meet his or her needs using interface 348.

Fields 350 and 352 allow the system user to specify the time period for the market rates. Field 354 allows the system user to limit the market rate report to market rates on active contracts. Drop down menus 356, 358, 360, 362, 364, 366 and 368 allow the system user to tailor the market rate report to a job position/title, sector, contract type, client, industry, location and skill set, respectively. Further, the system user can select all or less than all of the sorting criteria under each of the aforementioned drop down menus. For example, drop down menu 368 allows a system user to be able to select one or all of the listed skills. Further, a system user can select more than one but less than all of the listed skills. As depicted in FIG. 13, the user has customized the market rate report to two types of skills (i.e., 4^{th} Dimension and Ab Initio) out of a larger number of skills. The other drop down menus may be configured in a similar manner.

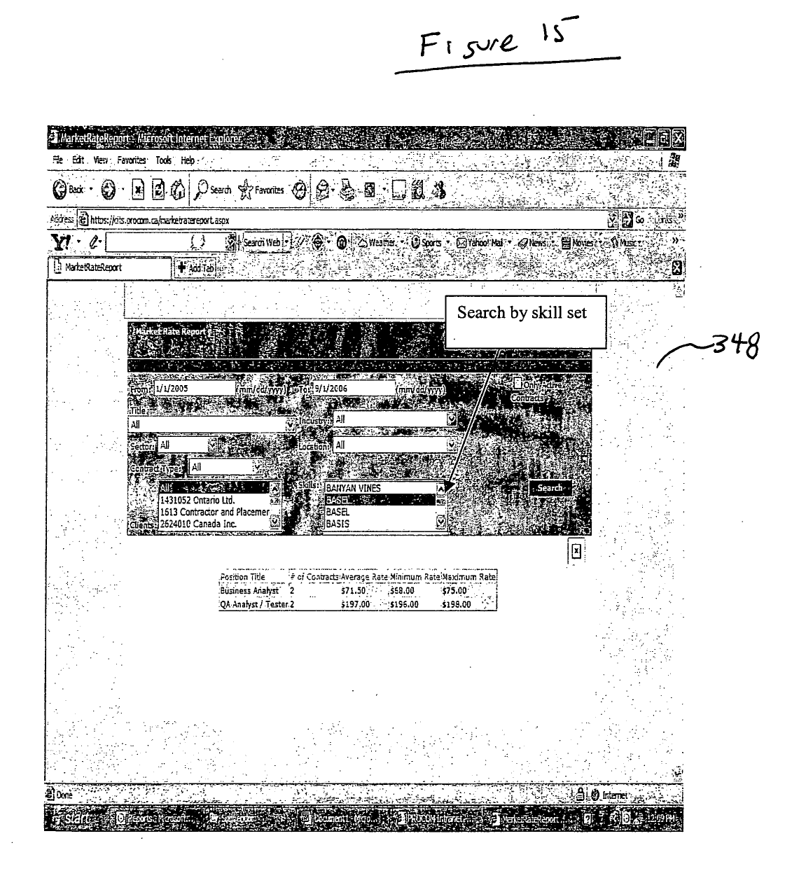

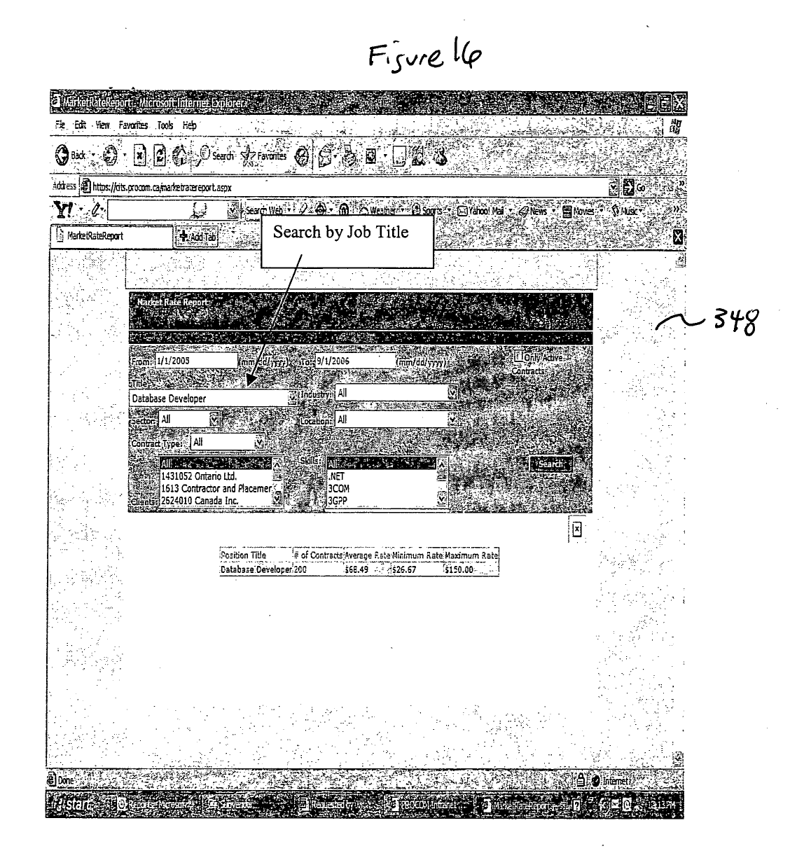

Referring to FIG. 14, interface 348 has been tailored to a particular client (i.e., PROCOM Consultants Group, Ltd.) for a particular time frame (i.e., Jan. 1, 2005 to Sep. 1, 2006) for all titles, sectors, industries, contract types, locations and skills. Referring to FIG. 15, interface 348 has been tailored to one skill (i.e., Basel) for a particular time frame (i.e., Jan. 1, 2005 to Sep. 1, 2006) for all titles, sectors, industries, contract types, locations and clients. Referring to FIG. 16, interface 348 has been tailored to one job title/position (i.e., database developer) for a particular time frame (i.e., Jan. 1, 2005 to Sep. 1, 2006) for all, sectors, industries, contract types, clients, locations and skills.

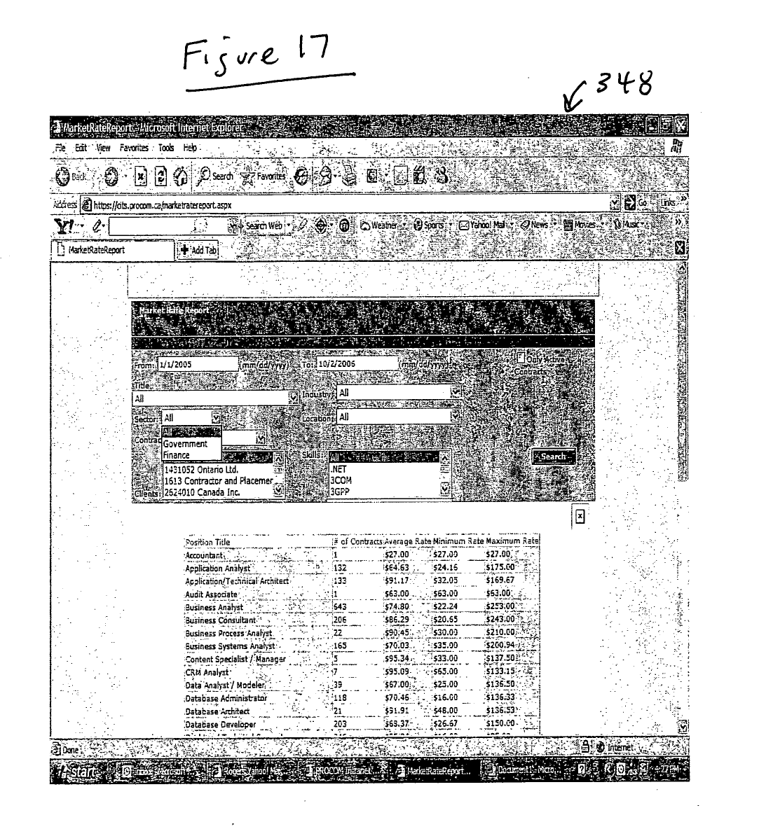

FIGS. 17 to 19 depict, inter alia, possible configurations for the sector, industry and location drop down menus, respectively.

In step 308 in the preferred process of creating and generating a market rate report, the system user merely clicks on “search” and the system searches for all corresponding information previously tracked and stored in the system and displays a market rate report. The system can be configured to allow the system user to print, transmit and/or store the market rate report. In step 310, the system can be further configured to allow a system user to export the market rate report to Microsoft Excel. It will be readily appreciated that the marker rate report feature of the present invention gives the system user virtually unlimited flexibility in tailoring a market rate report to the needs of the system user. The market rate report can be configured to provide a listing of an average market rate, a minimum market rate and a maximum market rate for each job position/title. (e.g., FIGS. 13 to 19) The market rate report can further be configured to identify the number of contracts from which the rates were obtained (e.g., FIGS. 13 to 19).

As previously explained, a user's access to the market rate reports feature of a preferred embodiment of the present invention may be restricted as desired. This can be accomplished by associating an access level with a system user's login indicia. For example, the market rate report feature could be limited to clients and vendors only. Further, the type of report that a particular system user can be created may be limited depending upon the system user's authorization level. It will be readily appreciated that any and all fields on the market rate report interface can be customized to meet the needs of each system user.

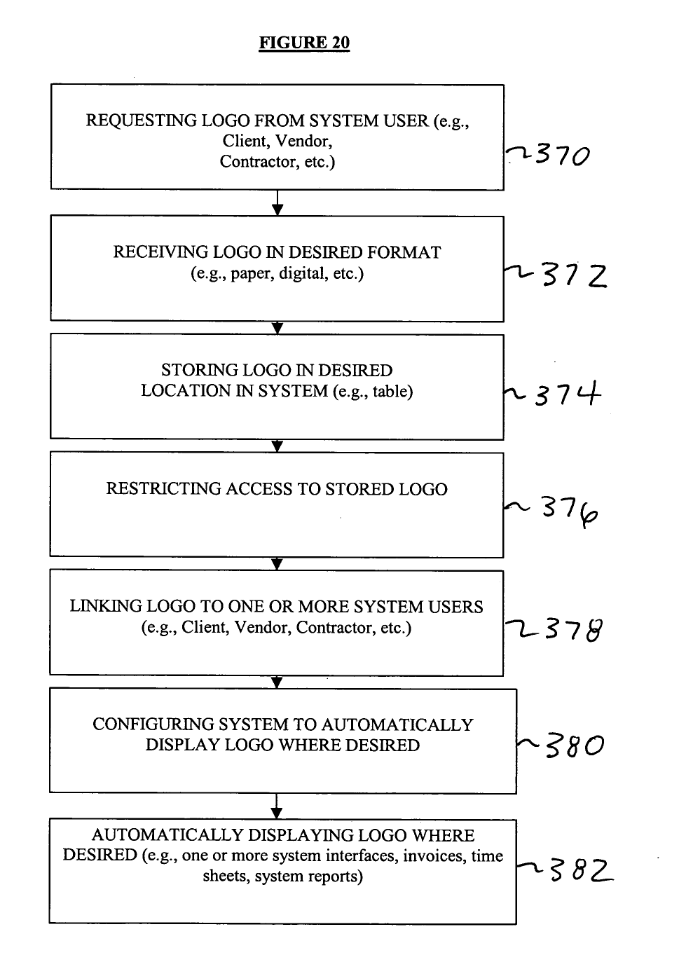

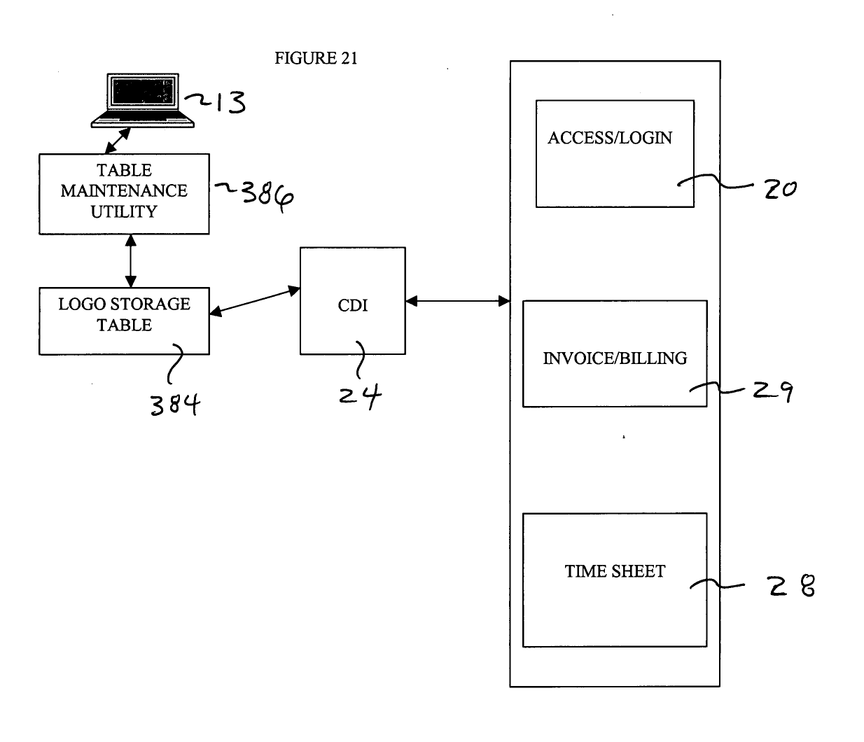

Referring to FIG. 20, a preferred method of logo management includes steps 370, 372, 374, 376, 378, 380 and 382. It will be readily appreciated that one or more steps may be omitted. Further, one or more steps may be consolidated. Moreover, the sequence of one or more steps may be varied. FIG. 21 shows the system components involved in the logo management feature of a preferred form of the present invention.

In step 370, the system administrator requests logos from various system users. It will be readily appreciated that the logo management feature can accommodate an unlimited number of logos from the client, vendor, sub-vendor, contractor and/or other system user. The logo management feature can also include one or more logos of the system administrator. In step 372, the logo or logos are received. The logos may be transmitted electronically or otherwise. In step 374, an administrator 13 or other designee stores the logos in a logo storage table 384 via table maintenance utility 386. It will be readily appreciated that the present invention is not limited to storage tables. Rather, any suitable storage mechanism may be used. Access to logos may be restricted in step 376. However, this step may be omitted. In step 378, one or more logos are linked to the corresponding system user. This indexing or linking step can be done by associating a logo to the login indicia (e.g., user name, password, etc.) of one or more system users. It may be necessary to associate other information with the logo to insure that the correct logo is displayed. For example, where a vendor and/or contractor are working with a number of clients, a contract number or other indicia specific to a particular client can also be linked to a logo. In step 380, the system is configured to automatically display the logo where desired. In step 382, the logo or logos are displayed where desired.

As illustrated in FIG. 21, CDI component 24 interacts with other elements of management component 12 including access/login component 20, invoice/billing component 29 and timesheet component 28 to display an appropriate logo where desired as illustrated in FIG. 21. In this manner, one or more logos may be displayed in any and all environments of the system including but not limited to any and all system interfaces, any and all communications issued by the system including but not limited to e-mails, reports (e.g., market rate reports), any and all timesheets and any and all invoices.

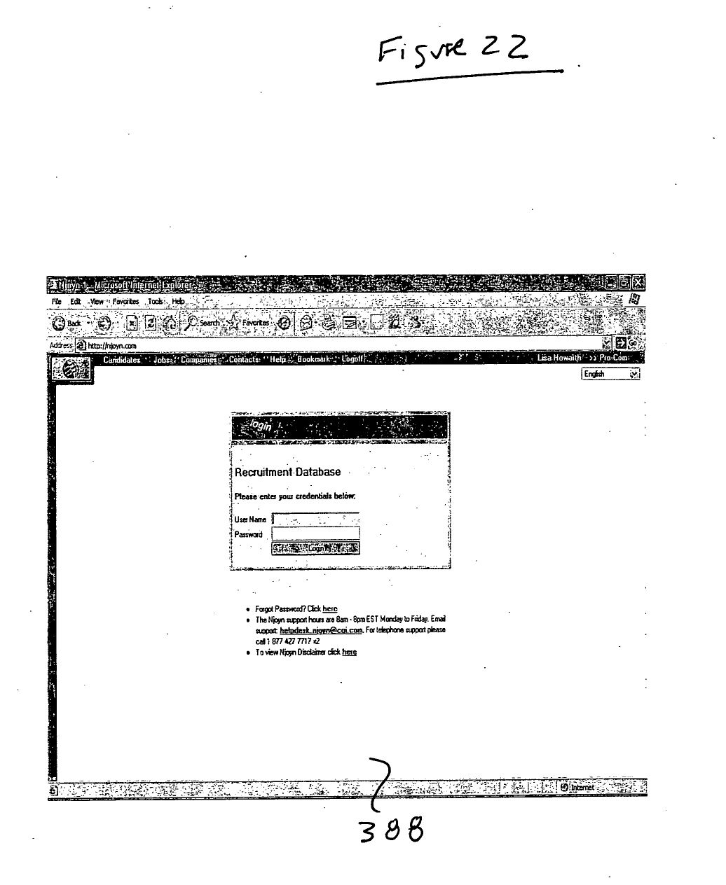

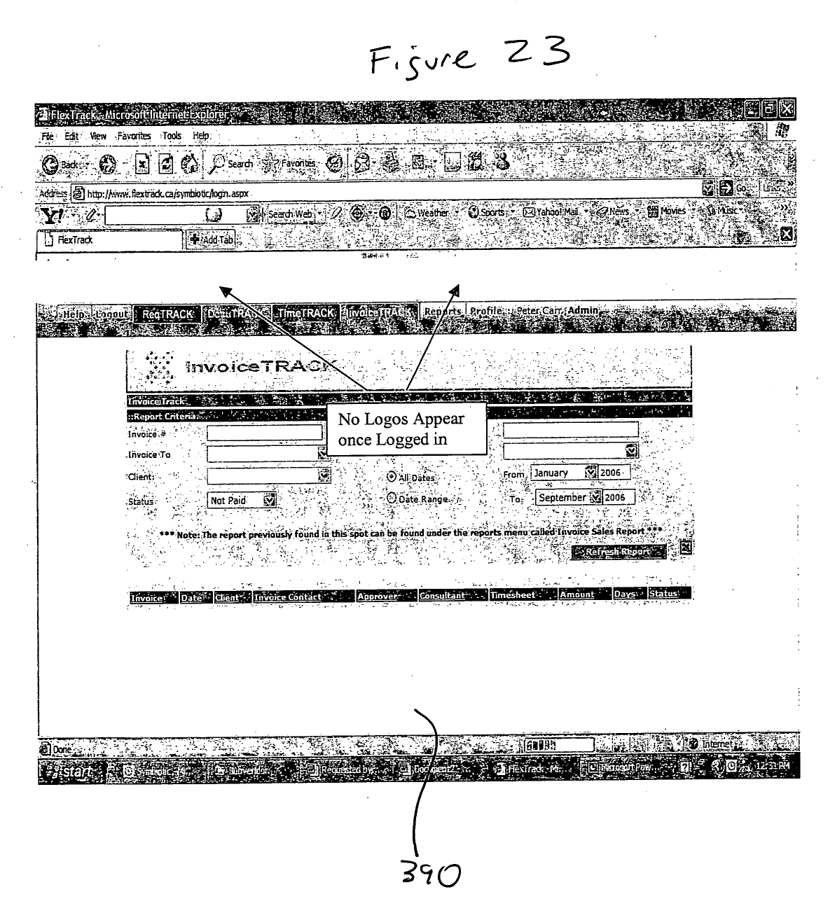

It will be readily appreciated that numerous configurations are possible. For example, the system can be configured such that a client logo is linked to the client or client designee and displayed in any desired environment of the system once the client or client designee logs in. Login screen 388 depicted in FIG. 22 is one of many possible configurations that may be used in a preferred form of the present invention. Where the client logo is linked to the client or client designee, a vendor logo may be linked to a particular vendor and/or one or more contractors so that the vendor logo is displayed in any desired environment of the system when the vendor and/or one or more contractors associated with that particular vendor log in. Alternatively, the client logo may be linked to the client, the vendor and the associated contractor such that the client logo is displayed in any desired environment once the client, vendor or the associated contractor login. The above to system may be used simultaneously for different client and different vendors. In either of the above two configurations, the system may be configured to display the administrator's logo along with the client logo and/or vendor logo. Moreover, the system may be configured such that no logo is linked to a particular client, vendor and associated contractor. In this instance, no logo is displayed when the client, vendor and/or associated contractor login as seen in Screenshot 390 depicted in FIG. 23. This configuration (no logo configuration) may be used simultaneously with the above two configurations for a different client, vendor and associated contractor.

The logo can be operably connected to the URL associated with a particular vendor or other system user so that the vendor's logo or other logo can be displayed on the login screen. Login screen 391 depicted in FIG. 24 illustrates a white-labeled login screen for a particular vendor.

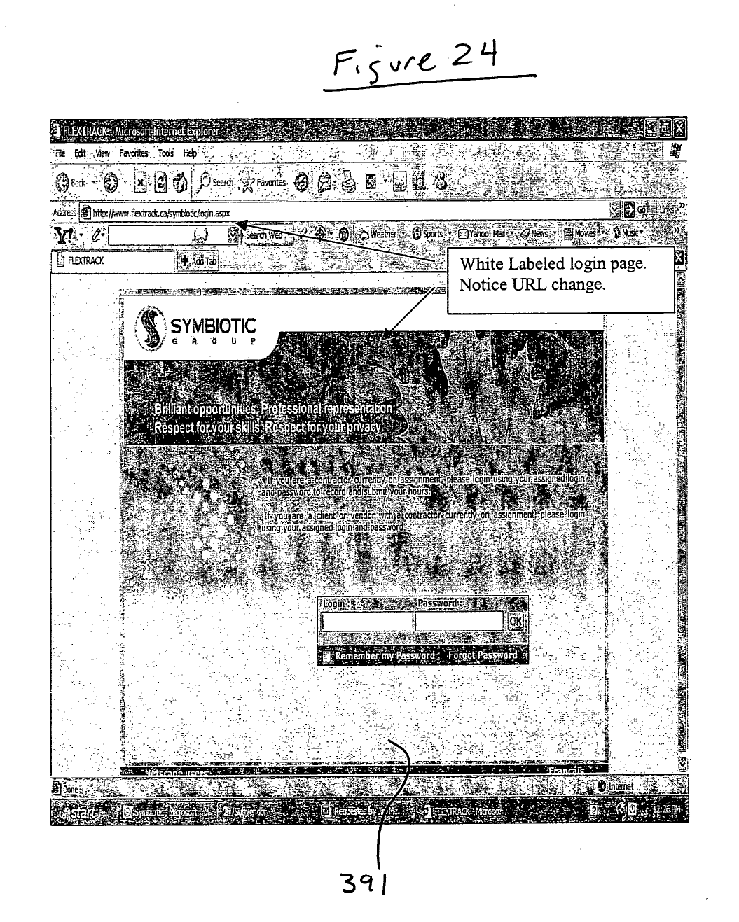

The logo management feature can white label any desired environment including but not limited to all user interfaces, invoices, timesheets, reports and communications issued by the system including but not limited to e-mails. Screenshot 392 depicted in FIG. 25 shows an example of a white-labeled invoice. The upper portion of screenshot 392 also displays the logos FLEXTRACK and TES, The Employment Solution and associated design that correspond to the system administrator and vendor, respectively. Screenshot 392 demonstrates the flexibility of the present invention. More specifically, an invoice displayed in a given user interface may be white-labeled while other portions of the system interface are not white-labeled but rather include logos of two or more different system users.

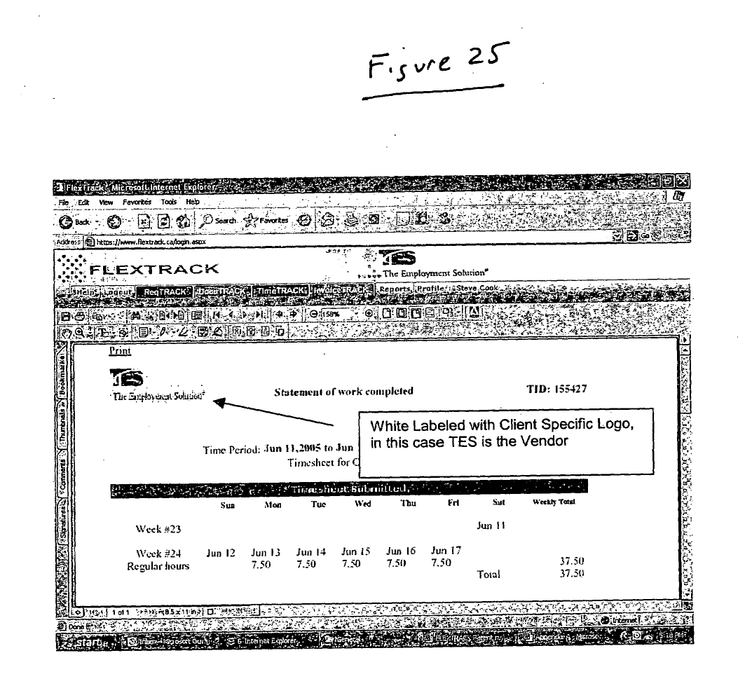

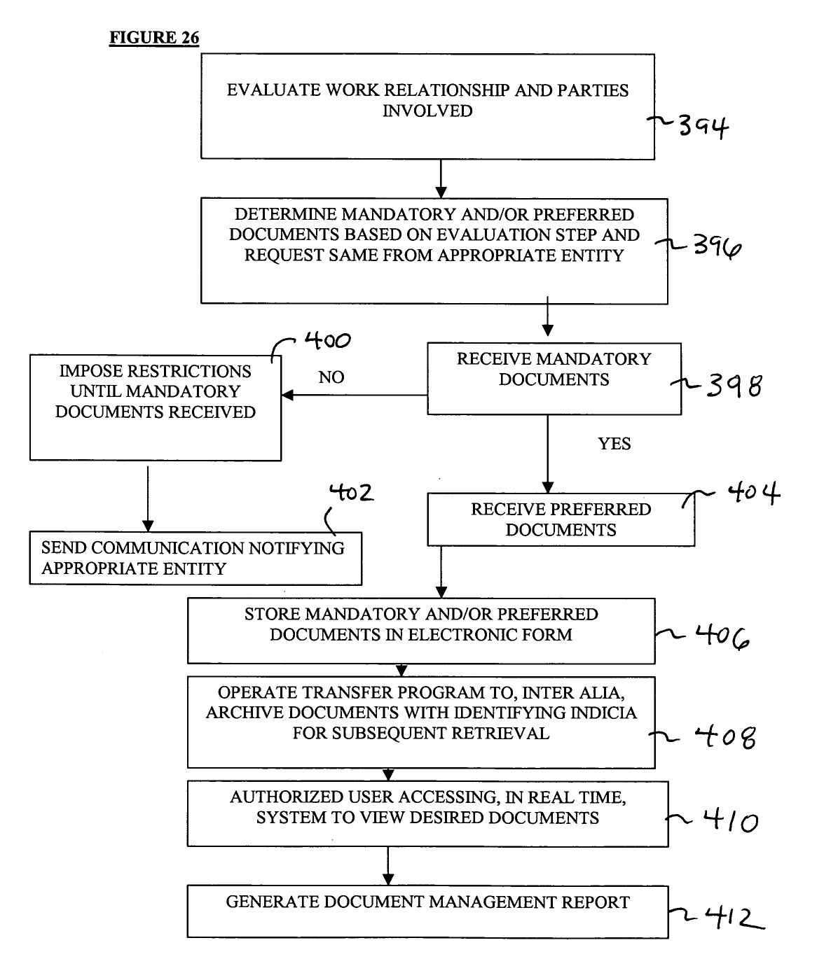

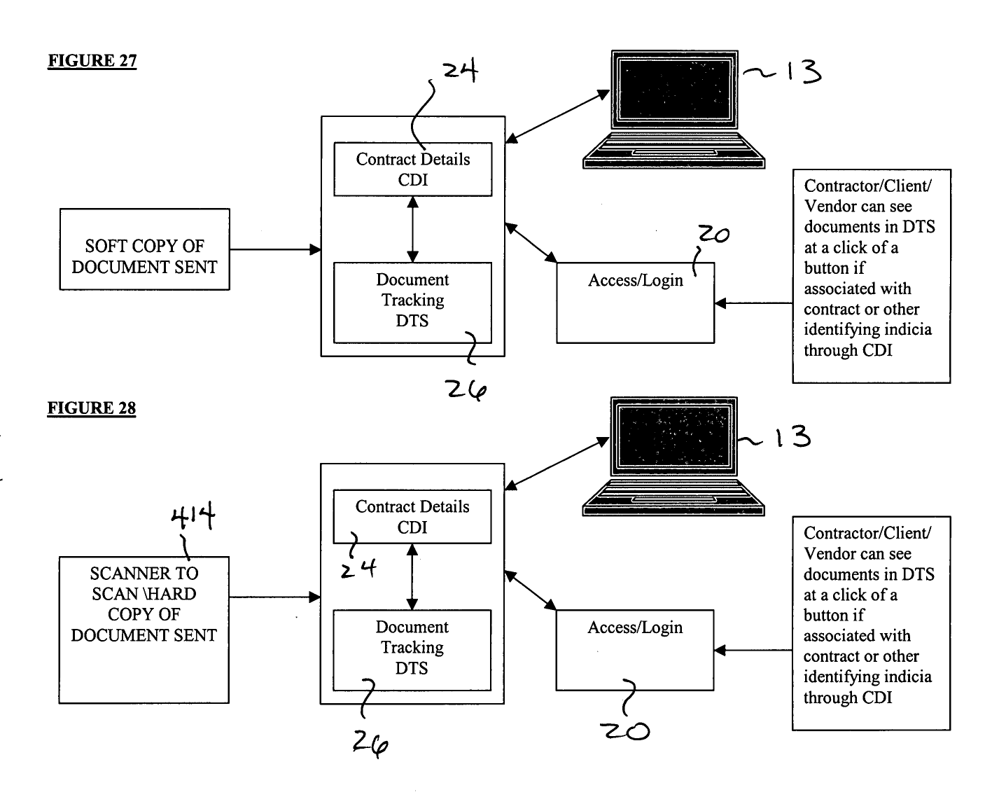

Referring to FIG. 26, a preferred method of document management includes steps 394, 396, 398, 400, 402, 404, 406, 408, 410 and 412. It will be readily appreciated that one or more steps may be omitted. Further, one or more steps may be consolidated. Moreover, the sequence of one or more steps may be varied. FIG. 27 illustrates the system components involved in the document management feature of a preferred form of the present invention when the document or documents are transmitted in soft form (e.g., electronically). The components include CDI 24, DTS 26, access/login 20. Administrator 13 is in two-way communication with these system components as illustrated in FIG. 27. The client, contractor and/or vendor can access the document management feature of the present invention through access/login 20 that is connected to CDI 24 and DTS 26. FIG. 28 illustrates the same system components as FIG. 27 and additionally includes a scanner 414 for scanning hard copies of documents that have been transmitted.

In step 394, the work relationship and the parties involved are evaluated. In step 396, the mandatory and/or preferred documents are identified based on the evaluation step and such documents are requested from the appropriate entity. Step 398 refers to receipt of mandatory documents. If the mandatory documents are received, then the process moves onto step 404. If the mandatory documents are not received, the process moves to step 400 in which restrictions are imposed on one or more system users. For example, if a particular contractor has not provided one or more required documents, the system can automatically preclude that contractor and/or associated vendor from entering time. Alternatively, the contractor and/or associated vendor may be precluded from submitting a time sheet for payment. In step 402, a notice may be sent to one or more system users (e.g., contractor, client, administrator and/or vendor) notifying the system user about the missing mandatory documents. If the mandatory documents and preferred documents are received, these documents are stored in electronic form in step 406. In step 408, the transfer program is operated by a system user (e.g., administer, contractor, client and/or vendor) to archive the documents with identifying indicia for subsequent retrieval. The transfer program is explained in greater detail below.

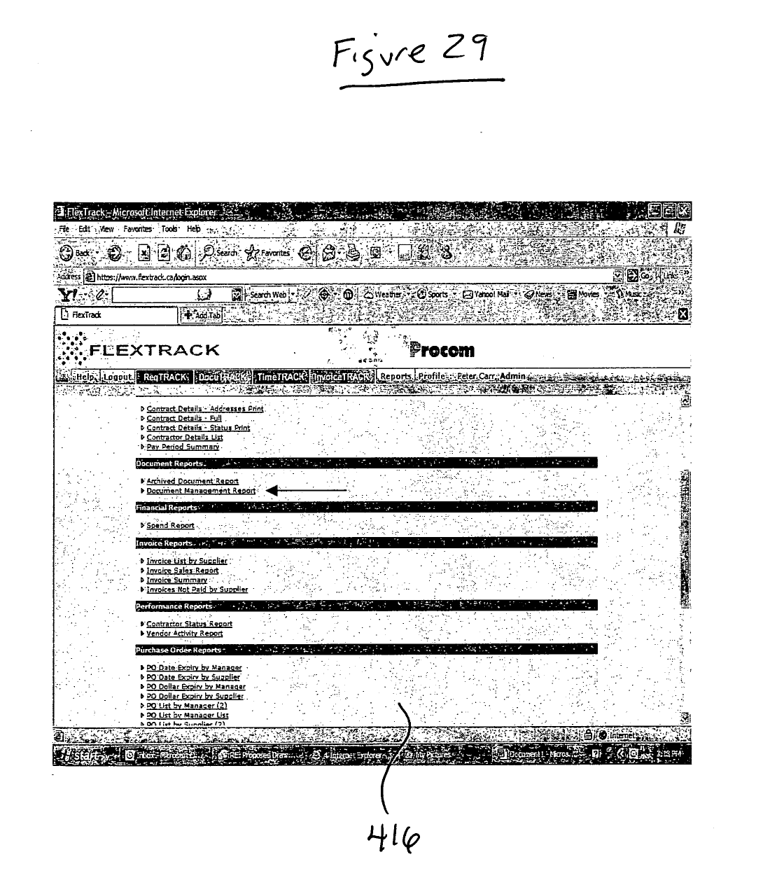

In step 410, an authorized system user (e.g., administrator, client, vendor and/or contractor) can view, in real time, one or more documents and or view a display indicating whether certain document have been received or not received. It will be readily appreciated that a system user's access to all or certain documents may be restricted. In step 412, a system user can generate a document management report. The user may generate a document management report by clicking on the Reports portion of an appropriate user interface screen that in turn displays user interface screen 416 illustrated in FIG. 29. The user need merely select “Document Management Report” in the listing of reports to be provided with another interface including one or more search fields for creating a document management report. As seen in screenshot 418 in FIG. 30, the search fields can include a client search field 420, client contact search field 422 and a consultant search field 424. It will be readily appreciated that the search fields may be varied as desired. Each of these search fields can be drop down menus that allow a user to select one or more clients, one or more client contacts and/or one or more consultants from the corresponding search field. In this manner, the system user can readily customize the document management report. Once the search criteria has been selected, the search is conducted by clicking on the search portion (not shown) of the interface 418. A document management report is generated and displayed. Screen shot 418 provides an example of a document management report that may be displayed. The document management report readily identifies whether a given document is stored in the system. A given document may be displayed by merely clicking on the appropriate portion of the document management report as shown in FIG. 30. While only certain documents are displayed in the document management report illustrated in FIG. 30, it will be readily appreciated that the system may be configured to report on and display any document desired.

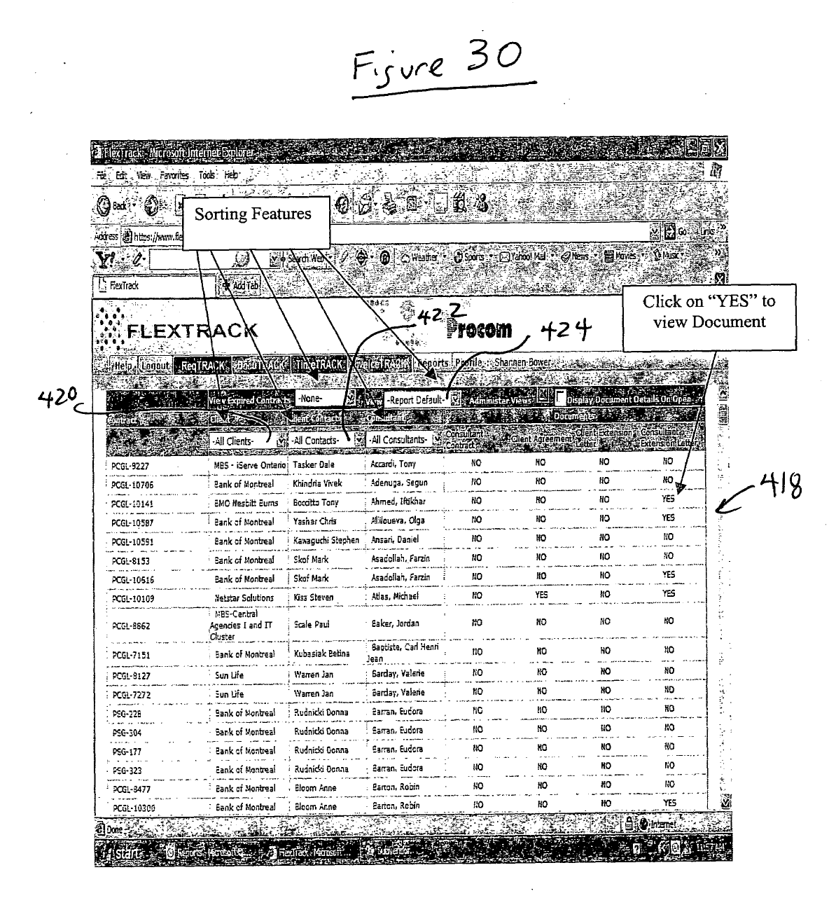

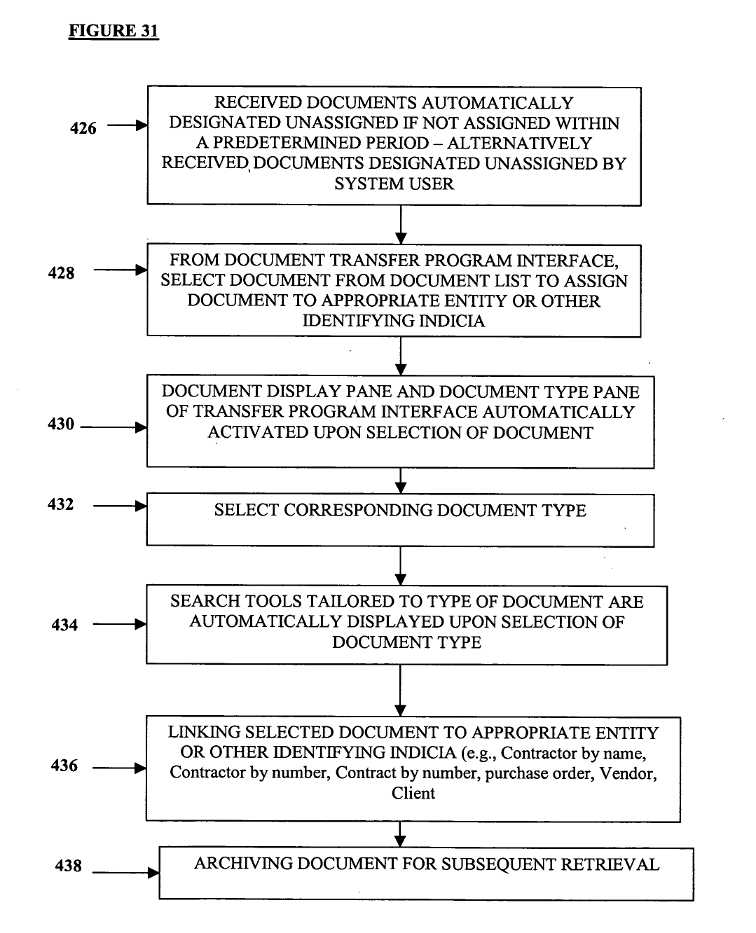

The preferred manner in which mandatory and/or preferred documents are archived for subsequent use including creation of a document management report will now be described. Referring to FIG. 31, a preferred transfer program is illustrated through which documents are archived for later use including but not limited to creation of document management reports. The preferred transfer process includes steps 426, 428, 430, 432, 434, 436 and 438. It will be readily appreciated that one or more steps may be omitted. Further, one or more steps may be consolidated. Moreover, the sequence of one or more steps may be varied.

A system user can start the transfer program through interface screen 440 illustrated in FIG. 31A. Specifically, the system user selects the appropriate directory (e.g., Document Tracking/General) to start the transfer program. Once the appropriate directory is selected, a transfer program interface 442 is displayed (e.g., FIG. 32). Preferably, interface 442 is divided into a document listing pane/section 444, a document type pane/section 446, a search pane/section 448 and a document display pane/section 450. Interface 442 includes a status bar 452 that identifies the number of new documents and the number of old documents.

Section 444 is a listing of newly received and older unassigned documents in the incoming documents queue. When the transfer program is started, received documents that have not been assigned within a predetermined period of time are automatically marked as older unassigned documents pursuant to step 426. Indicia or other identifiers may be used to distinguish the new documents from the older, unassigned documents. For example, the older, unassigned documents could appear in red while the newer documents appear in another color. Alternatively, documents may be marked as unassigned by selecting the particular document in section 444 and clicking on icon 453 pursuant to step 426.

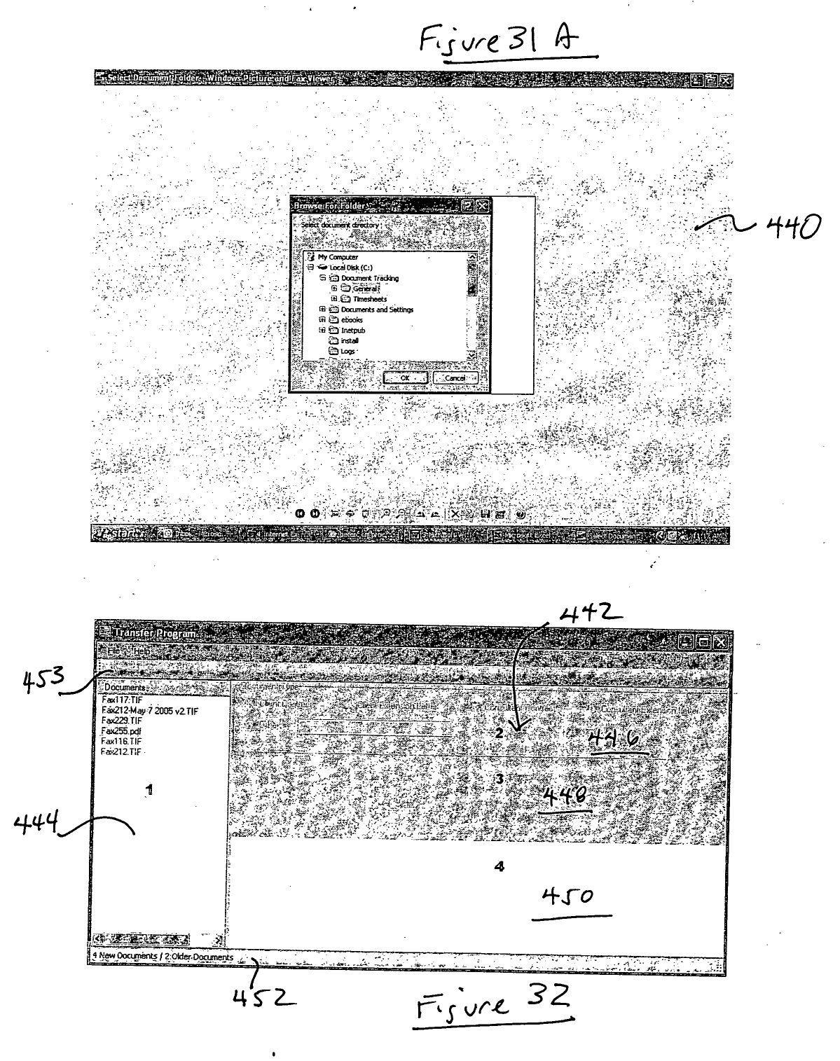

Section 446 is a document type pane. This section allows the system user (e.g., administrator, contractor, vendor and client) to identify any document selected from section 444. Section 450 is a display pane that allows the document to be displayed for viewing by a system user. As is seen in FIG. 32, section 446 is initially disabled and section 450 is initially empty. Referring to FIG. 33, once a document is selected from section 444 pursuant to step 428, section 446 is enabled and the particular document selected is displayed in section 450 pursuant to step 430. Preferably, a web browser or TIFF plug in is used to display the documents. However, any means may be used for displaying documents in section 450.

Referring to FIG. 33, section 446 preferably includes five radio buttons 454, 456, 458, 460 and 462 through which a system user can identify a document selected in section 444 pursuant to step 432. Upon selection of radio button 454, the document is identified as a client contract. Selection of radio button 456 identifies the document as a client extension letter. Selection of radio button 458 identifies the document as a consultant contract. Selection of radio button 460 identifies the document as a consultant extension letter. Selection of radio button 462 corresponding to “other,” activates a drop down menu from which a system user can select a particular type of document from a listing of a multitude of documents to identify the document selected in section 444. It should be noted that means other than radio buttons and drop down menus may be used to identify the type of document.

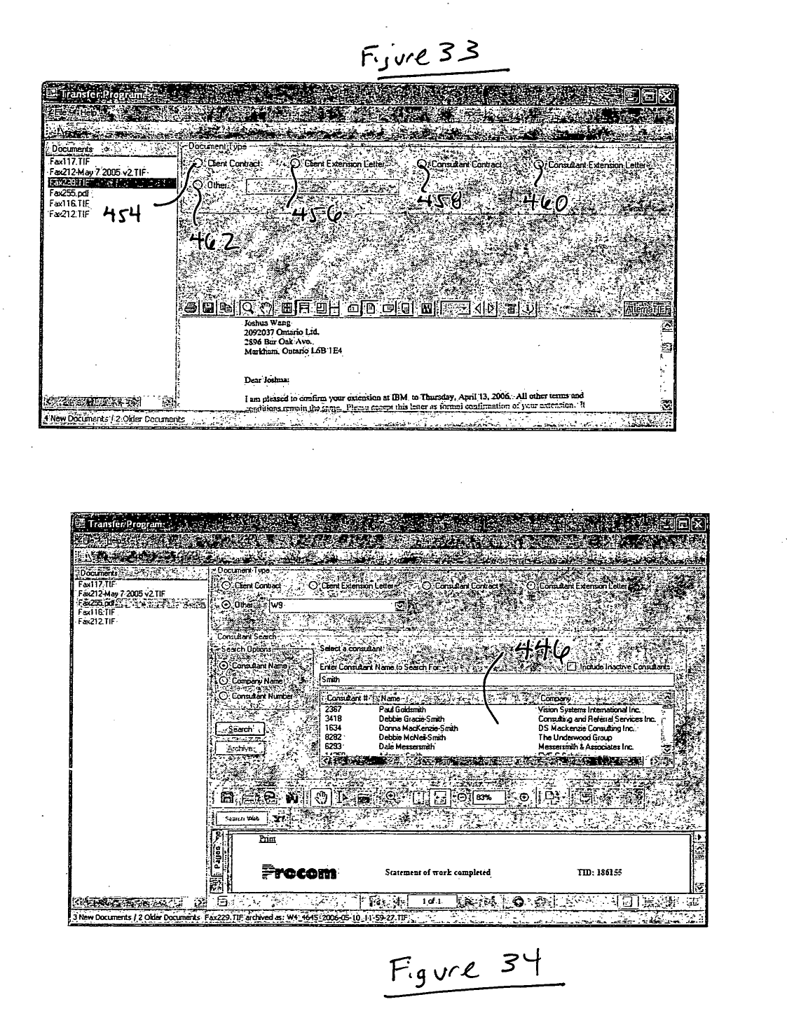

Once the type of document is identified using section 446, search criteria tailored to the type of document are displayed in search pane 448 as shown in screenshot 464 in FIG. 34 pursuant to step 434. More specifically, identification of the document as a W-9 results in the consultant search criteria being automatically displayed in section 448. A system user may search for a consultant by selecting one of several consultant search options (e.g., consultant name, company name or consultant number) and entering the appropriate information in the corresponding window. In screenshot 464, the system user has selected “consultant name” and entered “Smith” in the corresponding window. Once one of the entries in display field 466 is selected pursuant to step 436, the document can be archived by clicking on Archive 468 pursuant to step 438.

Each document type is associated with an entity type. For example, 401-K documents are associated with the consultant entity. The user must associate the 401-K document with a consultant in order to provide the information needed to archive the document. For consultant contract documents, a contract must be associated with the document.

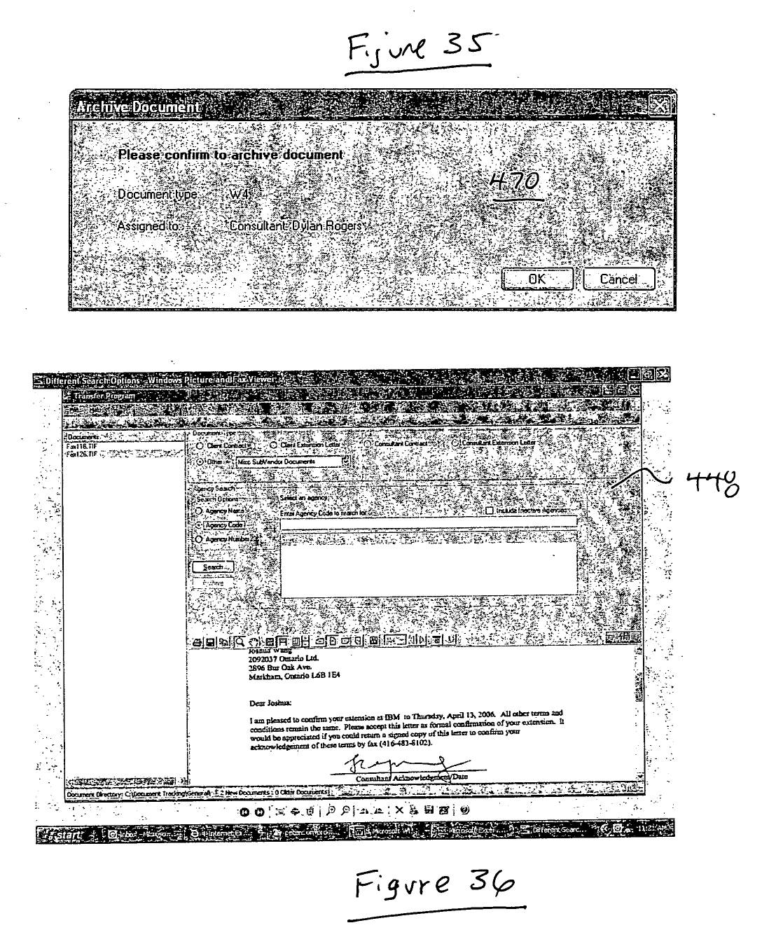

Referring to FIG. 35, a confirmation screen 470 can be displayed to allow the system user to confirm that the document is to be archived as well as the type of document and the individual to whom the document is to be assigned.

When archived, information about the document type and matching entity is encoded in the name. Also, information about the archived document and its location is saved in a database for later querying. Upon archiving a document, the status bar 452 is updated by updating the number of new and older documents in the documents queue. For example, if a document just archived was a new document, the number of new documents would automatically be reduced by one. Subsequently, the next document in the document list is selected and displayed in section 448 allowing the system user to repeat the above process.

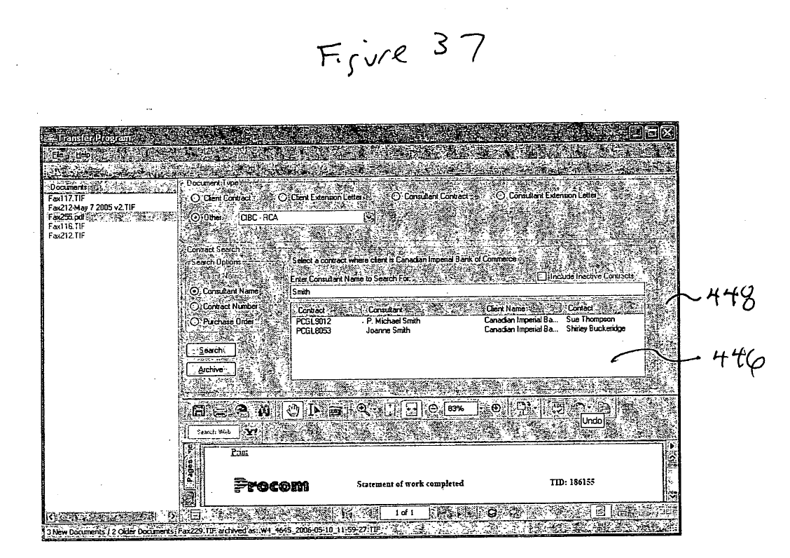

Referring to FIG. 36, the search criteria could include an agency search option where an agency can be searched for using an agency name, an agency code or an agency number. Referring to FIG. 37, the search criteria could include a contract search option that allows for contract searching by a client name, a consultant name, a contract number or a purchase order. Some documents may be associated with a specific entity. For such documents, search pane 448 is automatically limited to searching entries matching that particular entity. For example, the document type CIBC-RCA identified in section 446 in FIG. 37 is always associated with CIBC. As such, the search is limited to CIBC contracts. Other entity specific documents could be contracts specific to a particular consultant.

It will be readily appreciated that the search criteria and search options can be varied as desired.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

I claim:

1. An apparatus for managing time related work activities of at least one worker for at least one client, said apparatus comprising:
(a) a computer system, said computer system having a management component for managing at least one aspect of a work relationship; and
(b) said computer system further including a market rate report component for allowing a system user to create a market rate report reporting actual market rates of service providers, said market rate report component being configured to allow a system user to customize the market rate report reporting actual market rates of service providers using at least one of the following parameters: (i) title/position of service provider; and, (ii) skill set of service provider.

2. An apparatus, as set forth in claim 1, wherein:
(a) said market rate report component is configured to allow a system user to customize the market rate report reporting actual market rates of service providers using each of the following parameters: (i) title/position of service provider; and, (ii) skill set of service provider.

3. An apparatus, as set forth in claim 1, wherein:
(a) said market rate report component is configured to allow a system user to customize the market rate report reporting actual market rates of service providers using each of the following parameters: (i) title/position of service provider; (ii) skill set of service provider; (iii) geographic location; (iv) industry; (v) client; (vi) contract type, (vii) sector; and, (ix) time period.

4. An apparatus, as set forth in claim 1, wherein:
(a) said computer system further includes a requisition component, said requisition component being configured to track and manage procurement of labor resources, said requisition component including one or more user interfaces for allowing a client or a service provider to enter information relating to procurement of labor resources, said information including at least two of the following: (i) title/position, (ii) skills, (iii) industry, (iv) rate; (v) location; and (vi) status.

5. An apparatus, as set forth in claim 4, wherein:
(a) said one or more user interfaces are accessible by a plurality of clients and a plurality of service providers.

6. An apparatus for managing time related work activities of at least one worker for at least one client, said apparatus comprising:
(a) a computer system, said computer system having a requisition module, a time track module and a reporting module;
(b) said requisition module being configured to track and manage procurement of labor resources, said requisition module including one or more user interfaces for allowing a client or a service provider to enter information relating to procurement of labor resources, said information including at least two of the following: (i) title/position, (ii) skills, (iii) industry, (iv) rate; (v) location; and (vi) status;
(c) said time track module being configured to track and manage time spent by one of more laborers; and,
(d) said reporting module being configured to allow a system user to create a market rate report reporting actual market rates from said information relating to procurement of labor resources entered by said client or said service provider, said reporting module being further configured to allow a system user to customize the market rate report to provide actual market rates of service providers specific to at least one of the following parameters: (i) title/position; (ii) skills; (iii) sector; (iv) industry; and (v) location.

7. An apparatus, as set forth in claim 6, wherein:
(a) said computer system further includes a logo management component for storing a plurality of logos, said plurality of logos including a first logo identifying at least one client and a second logo identifying at least one vendor; said logo management component being configured to automatically and selectively display said first logo and said second logo at one or more desired locations in said computer system.

8. An apparatus, as set forth in claim 7, wherein:
(a) said computer system further includes a document tracking module for tracking documents relating to work activities of at least one worker for at least one client, said document tracking module has a user interface including a plurality of panes, said plurality of panes include: (i) a document listing pane for listing unassigned documents relating to work activities of at least one worker for at least one client; (ii) an identifying pane for identifying unassigned documents listed in said document listing pane; (iii) a search pane for searching for information to which a given document in the document listing pane is to be associated with; and, (iv) a document display pane for displaying one or more documents listed in the document listing pane.

9. An apparatus for managing time related work activities of at least one worker for at least one client, said apparatus comprising:
(a) a computer system, said computer system including a market rate report component for allowing a system user to create a market rate report reporting actual market rates of service providers, said market rate report component being configured to allow a system user to customize the market rate report reporting actual market rates of service providers using at least one of the following parameters: (i) title/position of a service provider; and, (ii) skill set of a service provider; and,
(b) said market rate report component including a user interface being configured to allow a system user to select one or more sorting criteria within at least one of said parameters.

10. An apparatus, as set forth in claim 9, wherein:
(a) said user interface being configured to allow a system user to select more than one sorting criteria but less than all of said sorting criteria within at least one of said parameters for creating said market rate report.

11. An apparatus, as set forth in claim 10, wherein:
(a) said sorting criteria includes a plurality of different skills.

12. An apparatus, as set forth in claim 9, wherein:
(a) said user interface has a first drop down menu for title/position of a service provider, said first drop down menu includes a listing of a plurality of titles/positions of a service provider that a system user may select from to customize said market rate report; and,
(b) said user interface has a second drop down menu for skills of a service provider, said second drop down menu includes a listing of a plurality of skills of a service provider that a system user may select from to customize said market rate report.

13. An apparatus, as set forth in claim 12, wherein:
(a) said user interface has a third drop down menu corresponding to a sector, said third drop down menu includes a listing of a plurality of sectors that a system user may select from to customize said market rate report;
(b) said user interface has a fourth drop down menu corresponding to geographic locations, said fourth drop down menu includes a listing of a plurality of geographic locations that a system user may select from to customize said market rate report;
(c) said user interface has a fifth drop down menu corresponding to clients, said fifth drop down menu includes a listing of clients that a system user may select from to customize said market rate report; and,
(d) said user interface has a sixth drop down menu corresponding to contract type, said sixth drop down menu includes a listing of contract types that a system user may select from to customize said market rate report.

14. An apparatus for managing time related work activities of at least one worker for at least one client, said apparatus comprising:
(a) a computer system, said computer system having at least one of the following: (i) requisition tracking module for tracking and managing procurement of labor resources; (ii) invoice tracking module for preparing and tracking invoices; (iii) document tracking module for tracking documents relating to work activities of at least one worker for at least one client; and (iv) time tracking module for tracking information related to time worked by at least one worker for at least one client; and,
(b) said computer system further including a logo management component for storing a plurality of logos, said plurality of logos including a first logo identifying one of a first client and a first vendor and a second logo identifying one of a second client and a second vendor, the first vendor being different from the second vendor and the first client being different from the second client; said logo management component being configured to automatically and selectively display said first logo and said second logo at one or more desired locations in said computer system.

15. An apparatus, as set forth in claim 14, wherein:
(a) said logo management component is configured to display at least one of said first and second logos on a plurality of different user interfaces when desired.

16. An apparatus, as set forth in claim 14, wherein:
(a) said logo management component is configured to display only one logo of said first logo and said second logo on a user interface when desired.

17. An apparatus, as set forth in claim 14, wherein:
(a) said logo management component is configured to display only a vendor logo on a login user interface when desired.

18. An apparatus, as set forth in claim 14, wherein:
(a) said logo management component is configured to display at least one of said first logo and said second logo on a user interface of said computer system, a time sheet created by said computer system and an invoice created by said computer system.

19. An apparatus, as set forth in claim 14, wherein:
(a) the first logo is a logo of a first vendor and the second logo is a logo of a second vendor; and,
(b) said logo management component is configured to differentiate a contractor represented by the first vendor and the second vendor such that an appropriate logo is automatically displayed on one of the following: (i) a time sheet of a contractor; (ii) an invoice of a contractor; and, (iii) a user interface.

20. A method for managing time related work activities of at least one worker for at least one client where the worker is represented by a vendor, said method comprising the steps of:
(a) providing a computer system having at least one of the following: (i) requisition tracking module for tracking and managing procurement of labor resources; (ii) invoice tracking module for preparing and tracking invoices; (iii) document tracking module for tracking documents relating to work activities of at least one worker for at least one client; and (iv) time tracking module for tracking information related to time worked by at least one worker for at least one client;
(b) providing the computer system further with a logo management component for storing a plurality of logos, the plurality of logos including a first logo identifying at least one client and a second logo identifying at least one vendor; and,
(c) automatically and selectively displaying the first logo and the second logo at one or more desired locations in the computer system.

21. An apparatus for managing time related work activities of at least one worker for at least one client, said apparatus comprising:
(a) a computer system, said computer system having a document tracking module for tracking documents relating to work activities of at least one worker for at least one client; and,
(b) said document tracking module including a user interface including a plurality of panes, said plurality of panes including a document listing pane for listing unassigned documents relating to work activities of at least one worker for at least one client, said plurality of panes further including an identifying pane for identifying unassigned documents listed in said document listing pane.

22. An apparatus, as set forth in claim 21, wherein:
(c) said identifying pane is configured to be inactive until a document is selected by a system user from said document listing pane.

23. An apparatus, as set forth in claim 21, wherein:
(a) said plurality of panes further includes a document display pane for displaying a document selected from said document listing pane.

24. An apparatus, as set forth in claim 21, wherein:
(a) said plurality of panes further includes a search pane for displaying one of a plurality of search options depending on an identification of a document, said search pane is configured to be inactive until a document is identified through said identifying pane.

25. An apparatus, as set forth in claim 24, wherein:
(a) said plurality of search options include contractor related search criteria, agency related search criteria and contract related search criteria.

26. An apparatus, as set forth in claim 25, wherein:
(a) said contractor related search criteria includes contractor name, contractor number and vendor name representing contractor.

27. An apparatus, as set forth in claim 25, wherein:
(a) said contract related search criteria includes client name, contractor name, contract number and purchase order.

28. An apparatus, as set forth in claim 25, wherein:
(a) said agency related search criteria includes agency name, agency code and agency number.

29. An apparatus, as set forth in claim 21, wherein:
(a) said computer system further including a reporting module for generating a document management report allowing a system user to determine if one or more documents have been received.

30. An apparatus, as set forth in claim 29, wherein:
(a) said reporting module includes a user interface having a plurality of sorting parameters through which a system user can customize said document management report.

31. An apparatus, as set forth in claim 30, wherein:
(a) said reporting module is configured to display said document management report and indicate whether one or more documents have been received.

32. An apparatus, as set forth in claim 31, wherein:
(a) said reporting module is configured such that when said document management report is displayed one or more documents may be viewed by a system user by clicking on a portion of said document management report.
